(19) United States
(12) Patent Application Publication
(10) Pub. No.: US 2022/0055378 A1
(43) Pub. Date: Feb. 24, 2022

(54) INKJET INK AND INKJET TEXTILE PRINTING METHOD

(71) Applicant: KYOCERA Document Solutions Inc., Osaka (JP)

(72) Inventor: Ryotaro KOMADA, Osaka-shi (JP)

(73) Assignee: KYOCERA Document Solutions Inc., Osaka (JP)

(21) Appl. No.: 17/403,156

(22) Filed: Aug. 16, 2021

(30) Foreign Application Priority Data
Aug. 18, 2020 (JP) 2020-138061

(51) Int. Cl. B41J 11/00; C09D 11/328; C09D 11/104; C09D 11/033; C09D 11/037; D06P 5/30; D06P 1/16; D06P 1/52; D06P 5/20; B41J 3/407

(52) U.S. Cl. CPC B41J 11/002; C09D 11/328; C09D 11/104; C09D 11/033; B41J 3/4078; D06P 5/30; D06P 1/16; D06P 1/5271; D06P 5/2077; C09D 11/037

(57) ABSTRACT

An inkjet ink includes an aqueous medium, composite particles, and a cross-linking agent. The composite particles are emulsified particles of a composite of a polyester resin and a disperse dye. The polyester resin includes at least one repeating unit derived from a polyhydric alcohol and at least one repeating unit derived from a polybasic carboxylic acid. The polyester resin is non-crystalline. The polyester resin has a glass transition point of at least 45° C. and no higher than 75° C. The polyester resin has an acid value of at least 10 mgKOH/g and no greater than 70 mgKOH/g. The polyester resin has a hydroxyl value of at least 20 mgKOH/g and no greater than 60 mgKOH/g. The cross-linking agent includes a blocked isocyanate.

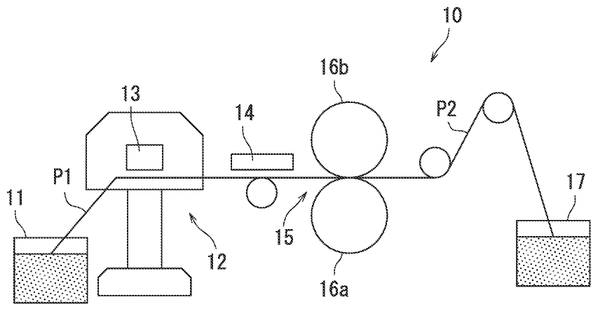

### INCORPORATION BY REFERENCE

The present application claims priority under 35 U.S.C. § 119 to Japanese Patent Application No. 2020-138061, filed on Aug. 18, 2020. The contents of this application are incorporated herein by reference in their entirety.

### BACKGROUND

The present disclosure relates to an inkjet ink and an inkjet textile printing method.

Digital textile printing inks have been investigated for printing images on manufactured textile articles such as cloth using an inkjet textile printing apparatus. For example, a hot-melt inkjet ink is known. The hot-melt inkjet ink is a solid ink which contains a dye and a water-soluble material that is solid at normal temperature and holds the dye in the ink.

### SUMMARY

An inkjet ink according to an aspect of the present disclosure includes an aqueous medium, composite particles, and a cross-linking agent. The composite particles are emulsified particles of a composite of a polyester resin and a disperse dye. The polyester resin includes at least one repeating unit derived from a polyhydric alcohol and at least one repeating unit derived from a polybasic carboxylic acid. The polyester resin is non-crystalline. The polyester resin has a glass transition point of at least 45° C. and no higher than 75° C. The polyester resin has an acid value of at least 10 mgKOH/g and no greater than 70 mgKOH/g. The polyester resin has a hydroxyl value of at least 20 mgKOH/g and no greater than 60 mgKOH/g. The cross-linking agent includes a blocked isocyanate.

An inkjet textile printing method according to another aspect of the present disclosure includes ejecting an ink from a recording head onto a textile printing target. The ink is the previously described inkjet ink.

### BRIEF DESCRIPTION OF THE DRAWING

FIGURE is a diagram illustrating an example of an inkjet textile printing apparatus used in an inkjet textile printing method according to a third embodiment of the present disclosure.

### DETAILED DESCRIPTION

First, the definitions of terms and the measurement methods used in the present specification are described. The term “-based” may be appended to the name of a chemical compound in order to form a generic name encompassing both the chemical compound itself and derivatives thereof. When the term “-based” is appended to the name of a chemical compound used in the name of a polymer, the term indicates that a repeating unit of the polymer originates from the chemical compound or a derivative thereof. Unless otherwise stated, a “main component” of a material refers to the component making up the largest proportion of the material in terms of mass. Hydrophobic strength (or hydrophilic strength) may be represented by the contact angle (wettability) of a droplet, for example.

Hydrophobicity increases as the contact angle of a droplet increases. Unless otherwise stated, one type of each component mentioned in the present specification may be used independently or two or more types thereof may be used in a combination. Unless otherwise stated, a softening point (Tm) refers to a value measured using a capillary rheometer (“CFT-500D”, product of Shimadzu Corporation). Unless otherwise stated, a number average molecular weight (Mn) and a mass average molecular weight (Mw) are values measured by gel permeation chromatography. The definitions of terms and the measurement methods used in the present specification are described thus far. The following describes embodiments of the present disclosure.

### First Embodiment: Inkjet Ink

The first embodiment of the present disclosure relates to an inkjet ink (referred to in the following as an ink). The ink of the first embodiment may be used for printing an image on a textile target using an inkjet textile printing apparatus, for example. That is, the ink of the first embodiment can be used as a digital textile printing ink. Digital textile printing has advantages over screen printing and rotary screen printing in that a sizing agent removal process is unnecessary and that dye wastewater can be reduced. Furthermore, digital textile printing has advantages over yarn-dyeing and dip-dyeing methods which involve dyeing a large number of fibers in that small lots may be printed and waste liquid is not generated in changing dye colors.

The ink of the first embodiment includes an aqueous medium, composite particles, and a cross-linking agent. The ink of the first embodiment is a water-based ink containing an aqueous medium. Preferably, the ink further contains a neutralizer as necessary. The composite particles, the cross-linking agent, the neutralizer, and the aqueous medium are described in the following.

<Composite Particles>

The composite particles are emulsified particles of a composite of a polyester resin and a disperse dye. The composite particles are dispersed (e.g., emulsion dispersed) in the aqueous medium, for example. When an ink including the composite particles lands on a textile printing target (e.g., a manufactured textile article such as a polyester cloth or a cotton cloth), the composite particles adhere to the textile printing target through the polyester resin in the composite particles. As a result, the color fastness to rubbing of a textile-printed image improves.

When the ink including the composite particles lands on a textile printing target and is heat-treated, a cross-linking agent cross-links a hydroxy group in the textile printing target and a hydroxy group in the polyester resin in the composite particles to form cross-linking structures. In the first embodiment, there is a large number of reaction sites where the polyester resin in the composite particles can react with the cross-linking agent due to the polyester resin having a hydroxyl value that is within a later-described prescribed range. Therefore, the cross-linking agent can sufficiently form cross-linking structures. As a result, the color fastness to rubbing of a textile-printed image particularly improves.

When the ink including the composite particles lands on a printing target and is heat-treated, both the polyester resin and the composite particles plastically deform on the textile printing target. Because the plastically deformed composite particles spread across the surface of the textile printing target, an image with a desired image density can be printed even when a small amount of the ink is used. In addition, unlike bleeding of a disperse dye that spreads along the fibers of a textile printing target due to capillary action, the dyed area spreads due to the plastic deformation of the composite particles, resulting in a clear image printed using the ink including the composite particles.

The volume median diameter (may be referred to in the following as D₅₀) of the composite particles is preferably at least 20 nm and no greater than 300 nm, more preferably at least 85 nm and no greater than 180 nm, and even more preferably at least 100 nm and no greater than 150 nm. By setting the D₅₀ of the composite particles to no greater than 300 nm, the composite particles are favorably emulsion dispersed in the aqueous medium and an ink with excellent dispersion stability is obtained. Furthermore, by setting the D₅₀ of the composite particles to no greater than 300 nm, the composite particles included in the ink to not readily agglomerate and the nozzles of a recording head are inhibited from clogging. Furthermore, the color developing property of a textile-printed image is improved. The D₅₀ of the composite particles can be adjusted by for example changing the acid value of the polyester resin contained in the composite particles. The D₅₀ of the composite particles tends to increase as the acid value of the polyester resin decreases. The D₅₀ of the composite particles can also be adjusted by for example changing the stirring conditions (specific examples include the stirring speed, the stirring time, and the presence or absence of a neutralizer) in a later-described composite particle adjustment process. The D₅₀ of the composite particles can also be adjusted by for example changing the type of the aqueous medium. The D₅₀ of the composite particles is measured through a method mentioned in Examples, for example.

The content ratio of the composite particles is preferably at least 5% by mass and no greater than 50% by mass relative to the mass of the ink, and more preferably at least 10% by mass and no greater than 40% by mass.

(Polyester Resin Constituting Composite Particles)

The polyester resin constituting the composite particles is non-crystalline. Here, a crystalline polyester resin is not easily dyed with a disperse dye. Conversely, a non-crystalline polyester resin is easily dyed with a disperse dye. This is because a crystalline region of the polyester resin is dense and does not easily soften, while a non-crystalline region thereof softens as the temperature rises, weakening the entanglement of resin chains and allowing the disperse dye to easily permeate. By dyeing the non-crystalline region of the non-crystalline polyester resin with a disperse dye, the non-crystalline polyester resin favorably forms a composite with the disperse dye. The polyester resin can be confirmed to be non-crystalline through differential scanning calorimetry (DSC), for example. When the polyester resin has a glass transition point (Tg) but does not have a clear melting point (Mp), the polyester resin is determined to be non-crystalline. Note that when the polyester resin has a glass transition point (Tg) and a melting point (Mp), the polyester resin is determined to be crystalline.

The polyester resin has a glass transition point of at least 45° C. and no greater than 75° C. By setting the glass transition point of the polyester resin to at least 45° C., the polyester resin does not easily soften at room temperature and fusion and agglomeration between the composite particles in the ink does not readily occur. As a result, an ink with excellent preservation stability is obtained. By contrast, by setting the glass transition point of the polyester resin to no greater than 75° C., a textile-printed image does not become excessively hard. As a result, swelling and sagging do not readily occur in a textile print, and tactile degradation of the textile print can be inhibited. Furthermore, when the glass transition point of the polyester resin is no greater than 75° C., the composite particles containing the polyester resin favorably adhere to the textile printing target even when the ink including the composite particles is not heated or is heated at a low temperature after landing on the textile printing target. As a result, the color fastness to rubbing of a textile-printed image improves. Furthermore, by setting the glass transition point of the polyester resin to at least 45° C. and no greater than 75° C., the composite particles favorably plastically deform on the textile printing target when the ink including the composite particles lands on the textile printing target and the textile printing target is heated. Because the plastically deformed composite particles spread across the surface of the textile printing target, an image with a desired image density can be printed even when a small amount of the ink is used. To obtain an ink with excellent preservation stability, the glass transition point of the polyester resin is preferably at least 50° C., and more preferably at least 55° C. To inhibit tactile degradation of a textile print, the glass transition point of the polyester resin is preferably no higher than 70° C. and more preferably no higher than 60° C. The glass transition point of the polyester resin is measured by a method mentioned in Examples, for example.

The polyester resin has an acid value of at least 10 mgKOH/g and no greater than 70 mgKOH/g. By setting the acid value of the polyester resin to at least 10 mgKOH/g, the amount of the carboxy group in the polyester resin increases and a suitable polarity is imparted to the polyester resin. As a result, the composite particles containing the polyester resin are favorably emulsion dispersed in the aqueous medium, and thus an ink with excellent dispersibility is obtained. Furthermore, phase inversion emulsification as described later in a second embodiment suitably proceeds. Also, an ink capable of textile-printing an image with few image defects is obtained. By contrast, by setting the acid value of the polyester resin to no greater than 70 mgKOH/g, the amount of the hydrophilic carboxy group does not become excessively large and suitable water resistance is imparted to the polyester resin. As a result, the color fastness to wet rubbing of a textile-printed image improves. To obtain an ink with excellent dispersibility, the acid value of the polyester resin is preferably at least 20 mgKOH/g. To improve the color fastness to wet rubbing of a textile-printed image, the acid value of the polyester resin is preferably no greater than 60 mgKOH/g. The acid value of the polyester resin is measured by a method mentioned in Examples, for example.

The polyester resin has a hydroxyl value of at least 20 mgKOH/g and no greater than 60 mgKOH/g. By setting the hydroxyl value of the polyester resin to at least 20 mgKOH/g, the amount of the hydroxy group in the polyester resin increases to increase the reaction sites at which the polyester resin can react with the cross-linking agent. As such, when the ink including the composite particles lands on a textile printing target and the textile printing target is heated, the cross-linking agent sufficiently forms cross-linking structures between the hydroxy group in the polyester resin in the composite particles and the hydroxy group in the textile printing target. As a result, image defects do not readily occur in a textile-printed image. By setting the hydroxyl value of the polyester resin to at least 20 mgKOH/g, the amount of the hydroxy group in the polyester resin increases and a suitable polarity is imparted to the polyester resin. As a result, the composite particles containing the polyester resin are favorably emulsion dispersed in the aqueous medium and an ink with excellent dispersibility can be obtained. By contrast, by setting the hydroxyl value of the polyester resin to no greater than 60 mgKOH/g, the amount of the hydroxy group which is hydrophilic does not become excessively large and suitable water resistance is imparted to the polyester resin. As a result, the color fastness to wet rubbing of a textile-printed image improves. By setting the hydroxyl value of the polyester resin to no greater than 60 mgKOH/g, the amount of the hydroxy group which is hydrophilic does not become excessively large and the textile print does not readily become slimy. As a result, tactile degradation of a textile print is inhibited. To inhibit occurrence of image defects and obtain an ink with excellent dispersibility, the hydroxyl value of the polyester resin is preferably at least 22 mgKOH/g, and more preferably at least 25 mgKOH/g. The hydroxyl value of the polyester resin is measured by a method mentioned in Examples, for example.

The softening point of the polyester resin is preferably at least 80° C. and less than 200° C. By setting the softening point to at least 80° C., an ink with favorable fixability and preservability can be obtained. So that the composite particles favorably adhere to the textile printing target, the softening point of the polyester resin is preferably at least 130° C. and no greater than 200° C.

The number average molecular weight of the polyester resin is preferably at least 2,500 and no greater than 30,000, more preferably at least 4,000 and no greater than 30,000, and even more preferably at least 10,000 and no greater than 30.000. By setting the number average molecular weight of the polyester resin to at least 2,500, the strength of an ink film on a textile print is increased. By setting the number average molecular weight of the polyester resin to no greater than 30,000, a liquid containing the polyester resin does not have an excessively high viscosity during composite particle preparation. As a result, a uniform composite of the polyester resin and the disperse dye can be formed.

The content ratio of the polyester resin in the composite particles is preferably at least 50% by mass and less than 100% by mass. In the following, the “content ratio of the polyester resin in the composite particles” may be referred to as a “polyester resin ratio”. The polyester resin ratio corresponds to a percentage by mass of the polyester resin to the mass of the composite particles. By setting the polyester resin ratio to at least 50% by mass, the amount of the polyester resin becomes large. Therefore, the composite particles favorably adhere to the textile printing target when the ink lands on the textile printing target and the color fastness to rubbing of a printed image improves. To improve the color fastness to rubbing of a textile-printed image, the polyester resin ratio is preferably at least 60% by mass, and more preferably at least 70% by mass. To textile-print an image with a desired image density, the polyester resin ratio is preferably no greater than 95% by mass, and more preferably no greater than 90% by mass. The polyester resin ratio can be changed by changing the amount of the polyester resin and the amount of the disperse dye added in composite particle preparation, for example.

The polyester resin includes at least one repeating unit derived from a polyhydric alcohol and at least one repeating unit derived from a polybasic carboxylic acid. The polyester resin is a polymer of at least 1 polyhydric alcohol and at least 1 polybasic carboxylic acid. In the following description, examples of polybasic carboxylic acids and examples of polyhydric alcohols may respectively serve as examples of repeating units derived from polybasic carboxylic acids and repeating units derived from polyhydric alcohols. For example, when a polybasic carboxylic acid monomer is “A”, the repeating unit derived from the polybasic carboxylic acid is a “repeating unit derived from A”. For another example, when a polyhydric alcohol monomer is “B”, the repeating unit derived from the polyhydric alcohol is a “repeating unit derived from B”.

(Repeating Unit Derived from Polyhydric Alcohol)

Examples of a repeating unit derived from a polyhydric alcohol include a repeating unit derived from a dihydric alcohol and a repeating unit derived from a tri- or higher-hydric alcohol (first repeating unit). The repeating unit derived from a tri- or higher-hydric alcohol is preferably a repeating unit derived from a trihydric alcohol or tetrahydric alcohol.

The at least one repeating unit derived from a polyhydric alcohol preferably includes at least a first repeating unit derived from a tri- or higher-hydric alcohol, and the content ratio of the first repeating unit is preferably at least 0.5 mol % and no greater than 10.0 mol % in the total amount of the at least one repeating unit derived from a polyhydric alcohol, and more preferably at least 2.0 mol % and no greater than 6.5 mol %. In this case, the at least one repeating unit derived from a polyhydric alcohol further include a repeating unit derived from a dihydric alcohol in addition to the first repeating unit. In the following, the “content ratio of the first repeating unit derived from a tri- or higher-hydric alcohol in the total amount of the at least one repeating unit derived from a polyhydric alcohol” may be referred to as a “tri- or or higher-hydric alcohol ratio”. The tri- or higher-hydric alcohol ratio corresponds to a percentage of the amount (unit: mole) of the first repeating unit derived from a tri- or higher-hydric alcohol to the total amount (unit: mole) of the at least one repeating unit derived from a polyhydric alcohol. By setting the tri- or higher-hydric alcohol ratio to at least 0.5 mol % and no greater than 10.0 mol %, the hydroxyl value of the polyester resin can be favorably adjusted to a value within a prescribed range.

The at least one repeating unit derived from a polyhydric alcohol preferably includes at least a second repeating unit derived from ethylene glycol, and the content ratio of the second repeating unit in the total amount of the at least one repeating unit derived from a polyhydric alcohol is preferably at least 50.0 mol % and no greater than 90.0 mol %, more preferably at least 55.0 mol % and no greater than 70.5 mol %, and even more preferably at least 60.0 mol % and no greater than 70.0 mol %. In this case, the at least one repeating unit derived from a polyhydric alcohol further includes a repeating unit derived from a polyhydric alcohol other than ethylene glycol in addition to the repeating unit derived from ethylene glycol. In the following, the “content ratio of the second repeating unit derived from ethylene glycol in the total amount of the at least one repeating unit derived from a polyhydric alcohol” may be referred to as an “EG ratio”. The EG ratio corresponds to a percentage of the amount (unit: mole) of the second repeating unit derived from ethylene glycol to the total amount (unit: mole) of the at least one repeating unit derived from a polyhydric alcohol. By setting the EG ratio to at least 50.0 mol % and no greater than 90.0 mol %, the glass transition point of the polyester resin is favorably adjusted to a value within a prescribed range.

Because the hydroxyl value of the polyester resin is easily adjusted to a value within the prescribed range, the polyester resin preferably includes two or more repeating units derived from polyhydric alcohols, more preferably two to four repeating units derived from polyhydric alcohols, and even more preferably three or four repeating units derived from polyhydric alcohols.

Examples of a polyhydric alcohol usable for polymerization of the polyester resin include aliphatic polyhydric alcohols, alicyclic polyhydric alcohols, aromatic polyhydric alcohols, and other polyhydric alcohols.

The aliphatic polyhydric alcohols are aliphatic dihydric alcohols or aliphatic tri- or higher-hydric alcohols. Examples of the aliphatic dihydric alcohols include aliphatic dihydric alcohols having a carbon number of at least 2 and no more than 8 (specific examples include ethylene glycol, diethylene glycol, triethylene glycol, propanediol, 1,3-propanediol, 2,3-butanediol, 1,4-butanediol, 1,5-pentanediol, 1,6-hexanediol, neopentyl glycol, dimethylol heptane, dipropylene glycol, and 2,2,4-trimethyl-1,3-pentanediol), polyethylene glycol, polypropylene glycol, and polytetramethylene glycol. Examples of the aliphatic tri- or higher-hydric alcohols include sorbitol, 1,2,3,6-hexatetraol, pentaerythritol, dipentaerythritol, tripentaerythritol, 1,2,4-butanetriol, 1,2,5-pentanetriol, 2-methyl-1,2,3-propanetriol, 2-methyl-1,2,4-butanetriol, trimethylolethane, trimethylolpropane, and glycerin.

Examples of the alicyclic polyhydric alcohols include alicyclic polyhydric alcohols having a carbon number of at least 6 and no more than 12 (specific examples include 1,4-sorbitan, 1,4-cyclohexanediol, 1,4-cyclohexanedimethanol, 1,3-cyclohexane dimethanol, 1,2-cyclohexane dimethanol, and isosorbide), spiroglycol, tricvclodecanediol, tricyclodacane dimethanol, hydrogenated bisphenol A, a hydrogenated bisphenol A ethylene oxide adduct, and a hydrogenated bisphenol A propylene oxide adduct.

Examples of the aromatic polyhydric alcohols include bisphenol A, a bisphenol A alkylene oxide adduct, p-xylylene glycol, paraxylene glycol, meta-xylene glycol, ortho-xylene glycol, 1,4-phenylene glycol, 1,3,5-trihydroxymethylbenzene, a 1,4-phenylene glycol ethylene oxide adduct, bisphenoxvethanol fluorene, and bis(4-(2-hydroxyethoxy)phenyl)fluorene.

Examples of the other polyhydric alcohols include lactone-based polyester polyols obtained by ring-opening polymerization of lactones such as ε-caprolactone.

The polyhydric alcohols usable in polymerization of the polyester resin preferably include at least a bisphenol A alkylene oxide adduct. The molecules of the bisphenol A alkylene oxide adduct are relatively large, which creates a steric hindrance during crystallization. As such, by using the bisphenol A alkylene oxide adduct, crystalline regions do not readily form and a non-crystalline polyester resin with non-crystalline regions can be easily obtained. The number of moles added of alkylene oxide added to bisphenol A is preferably at least 2 and no more than 6, and is more preferably 2.

Specific examples of the bisphenol A alkylene oxide adduct include polyoxypropylene-(2.3)-2,2-bis(4-hydroxyphenyl)propane, polyoxyethylene-(2.0)-2,2-bis(4-hydroxyphenyl)propane, polyoxypropylene-(2.0)-2,2-bis(4-hydroxyphenyl)propane, polyoxypropylene-(2.2)-polyoxyethylene-(2.0)-2,2-bis(4-hydroxyphenyl)propane, polyoxypropylene(6)-2,2-bis(4-hydroxyphenyl)propane, polyoxypropylene-(2.2)-2,2-bis(4-hydroxyphenyl)propane, polyoxypropylene-(2.4)-2,2-bis(4-hydroxyphenyl)propane, and polyoxypropylene-(3.3)-2,2-bis(4-hydroxyphenyl)propane.

The bisphenol A alkylene oxide adduct is preferably an alkylene oxide adduct having a carbon number of at least 2 and no more than 4 of bisphenol A, more preferably a bisphenol A ethylene oxide adduct or bisphenol A propylene oxide adduct, even more preferably a bisphenol A propylene oxide adduct, and particularly preferably a 2-molar propylene oxide adduct of bisphenol A.

The polyhydric alcohols usable in polymerization of the polyester resin preferably include at least an aliphatic alcohol. Due to the polyhydric alcohol including an aliphatic alcohol, the glass transition point of the polyester resin can be favorably adjusted to a value within the prescribed range. The aliphatic polyhydric alcohol is preferably an aliphatic dihydric alcohol or an aliphatic tri- or higher-hydric alcohol. The aliphatic dihydric alcohol is preferably ethylene glycol or diethylene glycol. The aliphatic tri- or higher-hydric alcohol is preferably pentaerythritol, trimethylolpropane, or glycerin.

The polyhydric alcohols usable in polymerization of the polyester resin preferably include at least one polyhydric alcohol selected from the group consisting of bisphenol A alkylene oxide adducts, dihydric aliphatic alcohols, and tri- or higher-hydric aliphatic alcohols, more preferably at least one and no more than four polyhydric alcohols selected from the above group, even more preferably at least two and no more than four polyhydric alcohols selected from the above group, and particularly preferably three or four polyhydric alcohols selected from the above group. In this case, the selected polyhydric alcohol preferably includes a tri- or higher-hydric aliphatic alcohol.

The polyhydric alcohols usable in polymerization of the polyester resin preferably include at least one polyhydric alcohol selected from the group consisting of bisphenol A alkylene oxide adducts (specifically, bisphenol A propylene oxide adducts), ethylene glycol, pentaerythritol, trimethylolpropane, glycerin, and diethylene glycol, more preferably at least one and no more than four polyhydric alcohols chosen from the above group, even more preferably at least two and no more than four polyhydric alcohols selected from the above group, and particularly preferably three or four polyhydric alcohols selected from the above group. In this case, the selected polyhydric alcohol preferably includes either or both of trimellitic acid and pyromellitic acid.

A repeating unit derived from a bisphenol A alkylene oxide adduct, a repeating unit derived from ethylene glycol, a repeating unit derived from pentaerythritol, a repeating unit derived from trimethylolpropane, a repeating unit derived from glycerin, and a repeating unit derived from diethylene glycol are respectively represented by the following general formula (3A), and chemical formulas (3B), (3C), (3D), (3E), and (3F). In general formula (3A), each R represents a linear or branched alkylene group (also referred to as an alkanediyl group), m represents an integer of at least 0, n represents an integer of at least 0, and the sum of m and n is at least 2 and no greater than 6. Each R preferably represents a linear or branched alkylene group having a carbon number of at least 2 and no more than 4, more preferably an ethylene group or a propylene group, and even more preferably a propylene group. The sum of m and n is preferably 2. The polyhydric alcohols usable in polymerization of the polyester resin have been described thus far

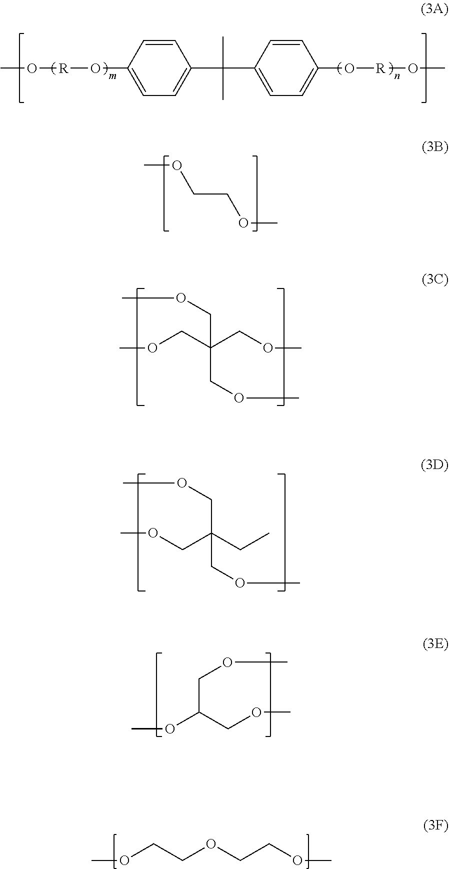

(Repeating Unit Derived from Polybasic Carboxylic Acid)

Examples of a repeating unit derived from a polybasic carboxylic acid include a repeating unit derived from a dicarboxylic acid and a repeating unit derived from a tri- or higher-basic carboxylic acid (third repeating unit). The repeating unit derived from a tri- or higher-basic carboxylic acid is preferably a repeating unit derived from a tricarboxylic acid or tetracarboxylic acid.

The at least one repeating unit derived from a polybasic carboxylic acid preferably includes at least the third repeating unit derived from a tri- or higher-basic carboxylic acid, and the content ratio of the third repeating unit is preferably at least 0.5 mol % and no greater than 9.0 mol % in the total amount of the at least one repeating unit derived from a polybasic carboxylic acid, and more preferably at least 1.5 mol % and no greater than 9.0 mol %. In this case, the at least one repeating unit derived from a polybasic carboxylic acid further includes a repeating unit derived from a dicarboxylic acid in addition to the third repeating unit. In the following, the “content ratio of the third repeating unit derived from a tri- or higher-basic carboxylic acid in the total amount of the at least one repeating unit derived from a polybasic carboxylic acid” may be referred to as a “tri- or higher-basic carboxylic acid ratio”. The tri- or higher-basic carboxylic acid ratio corresponds to a percentage of the amount (unit: mole) of the third repeating unit derived from a tri- or higher-basic carboxylic acid to the total amount (unit: mole) of the at least one repeating unit derived from a polybasic carboxylic acid. By setting the tri- or higher-basic carboxylic acid ratio to at least 0.5 mol % and no greater than 9.0 mol %, the acid value of the polyester resin can be favorably adjusted to a value within a prescribed range.

The at least one repeating unit derived from a polybasic carboxylic acid preferably includes at least a fourth repeating unit derived from a polybasic carboxylic acid with a sulfonic acid group (a polybasic carboxylic acid having a sulfonic acid group), and the content ratio of the fourth repeating unit in the total amount of the at least one repeating unit derived from a polybasic carboxylic acid is preferably greater than 0.0 mol % and no greater than 15.0 mol %, more preferably greater than 0.0 mol % and no greater than 10.0 mol %, and even more preferably greater than 0.0 mol % and no greater than 5.0 mol %. In this case, the at least one repeating unit derived from a polybasic carboxylic acid further includes a repeating unit derived from a polybasic carboxylic acid without a sulfonic acid group in addition to the fourth repeating unit. In the following, the “content ratio of the fourth repeating unit derived from a polybasic carboxylic acid with a sulfonic acid group in the total amount of the at least one repeating unit derived from a polybasic carboxylic acid” may be referred to as a “sulfonic acid unit ratio”. The sulfonic acid unit ratio corresponds to a percentage of the amount (unit: mole) of the fourth repeating unit derived from a polybasic carboxylic acid with a sulfonic acid group to the total amount (unit: mole) of the at least one repeating unit derived from a polybasic carboxylic acid. By setting the sulfonic acid unit ratio to greater than 0.0 mol % and no greater than 15.0 mol %, suitable hydrophilicity is imparted to the polyester resin. As a result, the composite particles containing the polyester resin are favorably emulsion dispersed in the aqueous medium and an ink with excellent dispersibility can be obtained. Furthermore, by setting the sulfonic acid unit ratio to greater than 0.0 mol % and no greater than 15.0 mol %, the polyester resin has suitable hydrophilicity as described above while also having suitable hydrophobicity to the degree that the polyester resin does not dissolve in the aqueous medium. As a result, the polyester resin in the composite particles does not dissolve in the aqueous medium and adhere to the inside of nozzles of a recording head included in an inkjet textile printing apparatus. Therefore, the nozzles can be inhibited from clogging. As a result, the ink is stably ejected from the nozzles and occurrence of image defects in a textile print is inhibited.

As an alternative to the aspect described above, it is also preferable that the at least one repeating unit derived from a polybasic carboxylic acid does not include the fourth repeating unit derived from a polybasic carboxylic acid with a sulfonic acid group. Due to the at least one repeating unit derived from a polybasic carboxylic acid not including the fourth repeating unit, suitable hydrophobicity is imparted to the polyester resin to the degree that the polyester resin does not dissolve in the aqueous medium. As a result, the polyester resin in the composite particles does not dissolve in the aqueous medium and adhere to the inside of nozzles of a recording head included in an inkjet textile printing apparatus. Therefore, the nozzles can be inhibited from clogging. As a result, the ink is stably ejected from the nozzles and occurrence of image defects in a textile print is inhibited.

Because the acid value of the polyester resin is easily adjusted to a value within the prescribed range, the polyester resin preferably includes two or more repeating units derived from a polybasic carboxylic acid, more preferably at least two and no more than four repeating units derived from a polybasic carboxylic acid, and more preferably three or four repeating units derived from a polybasic carboxylic acid.

Examples of polybasic carboxylic acids usable for polymerization of the polyester resin include aromatic dicarboxylic acids, aliphatic dicarboxylic acids, alicyclic dicarboxylic acids, and tri- or higher-basic carboxylic acids.

Examples of the aromatic dicarboxylic acids include terephthalic acid, isophthalic acid, naphthalenedicarboxylic acids (specific examples include 1,5-naphthalenedicarboxylic acid and 2,6-naphthalenedicarboxylic acid), benzyl malonic acid, 4,4′-dicarboxydiphenyl ether, diphenic acid, and phenylenediacrylic acid.

Examples of the aliphatic dicarboxylic acids include malonic acid, dimethyl malonic acid, succinic acid, glutaric acid, adipic acid, trimethyl adipic acid, pimelic acid, 2,2-dimethyl glutaric acid, azelaic acid, sebacic acid, dodecane dicarboxylic acid, fumaric acid, maleic acid, itaconic acid, thiodipropionic acid, diglycollic acid, mesaconic acid, and citraconic acid.

Examples of the alicyclic dicarboxylic acids include 1,3-cyclopentanedicarboxylic acid, 1,2-cyclohexanedicarboxylic acid, 1,3-cyclopentanedicarboxylic acid, 1,4-cyclohexanedicarboxylic acid, 2,5-norbornanedicarboxylic acid, and adamantanedicarboxylic acid.

Examples of the tri- or higher-basic carboxylic acids include aromatic tri- or higher-basic carboxylic acids and alicyclic tri- or higher-basic carboxylic acids. Examples of the aromatic tri- or higher-basic carboxylic acids include aromatic tricarboxylic acids and aromatic tetracarboxylic acids, more specifically trimellitic acid, trimesic acid, and pyromellitic acid. Examples of the alicyclic tri- or higher-basic carboxylic acids include adamantane tricarboxylic acid.

The polybasic carboxylic acids usable in polymerization of the polyester resin may have a sulfonic acid group. A polybasic carboxylic acid with a sulfonic acid group is preferably a dicarboxylic acid with a sulfonic acid group, and more preferably an aromatic dicarboxylic acid with a sulfonic acid group. Examples of the aromatic dicarboxylic acid with a sulfonic acid group include 5-sulfoisophthalic acid, 4-sulfophthalic acid, 2-sulfoterephthalic acid, 3,5-dicarbomethoxybenzenesulfonic acid, 4-sulfonaphthalene-2,7-dicarboxylic acid, and 5-(4-sulfophenoxy)isophthalic acid, as well as metal salts of the foregoing. The metal salts are preferably alkali metal salts, and more preferably sodium salts, potassium salts, or lithium salts.

The polybasic carboxylic acid usable in polymerization of the polyester resin is preferably at least one polybasic carboxylic acid selected from the group consisting of aromatic dicarboxylic acids, aromatic tri- or higher-basic carboxylic acids, and aromatic dicarboxylic acids with a sulfonic acid group, more preferably at least one and no more than four polybasic carboxylic acids selected from the above group, even more preferably at least two and no more than four polybasic carboxylic acids selected from the above group, and particularly preferably three or four polybasic carboxylic acids selected from the above group. In this case, the selected polybasic carboxylic acids preferably include at least an aromatic tri- or higher-basic carboxylic acid.

The polybasic carboxylic acids usable for polymerization of the polyester resin preferably include at least one polybasic carboxylic acid selected from the group consisting of terephthalic acid, isophthalic acid, trimellitic acid, pyromellitic acid, naphthalene dicarboxylic acid, and sodium 5-sulfoisophthalate, more preferably at least one and no more than four polybasic carboxylic acids selected from the above group, more preferably at least two and no more than four polybasic carboxylic acids selected from the above group, and particularly preferably three or four polybasic carboxylic acids selected from the above group. In this case, the selected polybasic carboxylic acids preferably include either or both trimellitic acid and pyromellitic acid.

A repeating unit derived from sodium 5-sulfoisophthalate, a repeating unit derived from terephthalic acid, a repeating unit derived from isophthalic acid, a repeating unit derived from trimellitic acid, a repeating unit derived from pyromellitic acid, and a repeating unit derived from naphthalene dicarboxylic acid are respectively represented by the following chemical formulas (1), (2A), (2B), (2C), (2D), and (2E). The repeating unit derived from naphthalene dicarboxylic acid is preferably represented by the following chemical formula (2F).

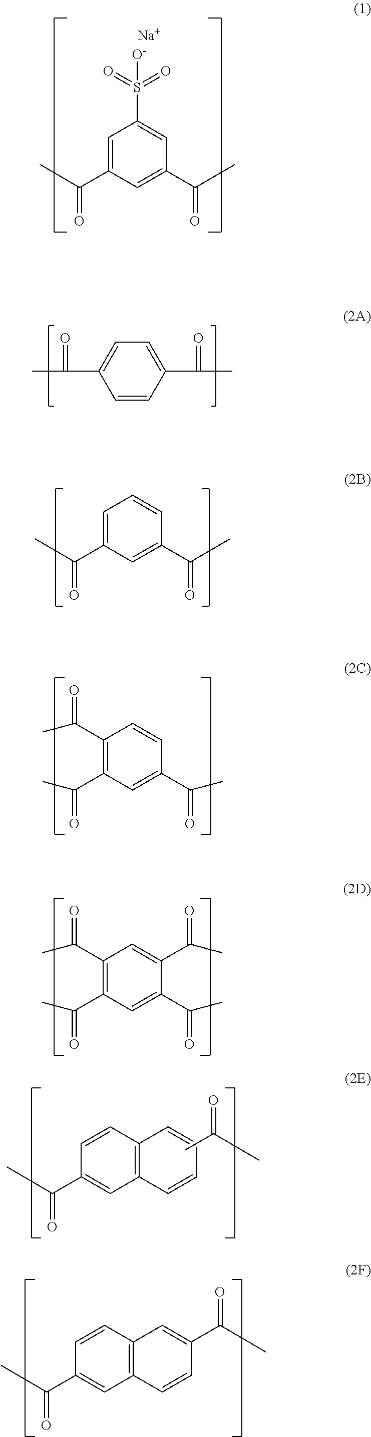

The polybasic carboxylic acids usable for polymerization of the polyester resin may be alkyl ester of any of the previously described polybasic carboxylic acids. Such an alkyl ester is preferably an alkyl ester having a carbon number of at least 1 and no more than 6, more preferably an alkyl ester having a carbon number of at least 1 and no more than 3, and even more preferably methyl ester. The polybasic carboxylic acids usable in polymerization of the polyester resin have been described thus far.

The following further describes the polyester resin constituting the composite particles. The at least one repeating unit derived from a polybasic carboxylic acid preferably includes at least a fifth repeating unit derived from a polybasic carboxylic acid with an aromatic hydrocarbon (a polybasic carboxylic acid having an aromatic hydrocarbon). Furthermore, the at least one repeating unit derived from a polyhydric alcohol preferably includes at least a sixth repeating unit derived from a polyhydric alcohol with an aromatic hydrocarbon (a polyhydric alcohol having an aromatic hydrocarbon). The total content ratio of the fifth and sixth repeating units is preferably at least 50 mol % in the total amount of the at least one repeating unit derived from a polybasic carboxylic acid and the at least one repeating unit derived from a polyhydric alcohol. In the following, the “total content ratio of the fifth repeating unit derived from a polybasic carboxylic acid with an aromatic hydrocarbon and the sixth repeating unit derived from a polyhydric alcohol with an aromatic hydrocarbon in the total amount of the at least one repeating unit derived from a polybasic carbonic acid and the at least one repeating unit derived from a polyhydric alcohol” may be referred to as an “aromatic ratio”. The aromatic ratio corresponds to a percentage of the total amount (unit: mole) of the fifth repeating unit derived from a polybasic carboxylic acid with an aromatic hydrocarbon and a sixth repeating unit derived from a polyhydric alcohol with an aromatic hydrocarbon to the total amount (unit: mole) of the at least one repeating unit derived from a polybasic carboxylic acid and the at least one repeating unit derived from a polyhydric alcohol. By setting the aromatic ratio to at least 50 mol %, the glass transition point of the polyester resin is favorably adjusted to a value within the prescribed range. Furthermore, the disperse dye contained in the composite particles often has aromatic hydrocarbons. As such, by setting the aromatic ratio to at least 50 mol %, the aromatic hydrocarbons in the disperse dye and the aromatic hydrocarbons in the polyester resin are stacked to increase interaction therebetween, and the disperse dye and the polyester resin can easily become a composite. The aromatic ratio is more preferably at least 50 mol % and no greater than 90 mol %, even more preferably at least 50 mol % and no greater than 80 mol %, and still more preferably at least 50 mol % and no greater than 65 mol %.

Each of the previously described tri- or higher-hydric alcohol ratio, EG ratio, tri- or higher-basic carboxylic acid ratio, sulfonic acid unit ratio, and aromatic ratio can be measured by for example analyzing the polyester resin using a nuclear magnetic resonance (NMR) apparatus to obtain a ratio of a characteristic peak for each repeating unit.

To obtain a non-crystalline polyester resin in which the occupancy of non-crystalline regions is high, a polyhydric alcohol monomer and a polybasic carboxylic acid monomer are preferably selected so as not to regularly form crystalline regions. As the occupancy of the non-crystalline regions in the non-crystalline polyester resin increases, the non-crystalline polyester resin is more easily dyed by the disperse dye and composite particles are more easily produced.

The polyester resin is produced by condensation polymerization of at least 1 polyhydric alcohol and at least 1 polybasic carboxylic acid. The temperature for condensation polymerization is preferably at least 220° C. and no higher than 250° C. By setting the condensation polymerization temperature to at least 220° C., the productivity of the polyester resin becomes favorable. By setting the condensation polymerization temperature to no higher than 250° C., the polyester resin can be inhibited from decomposing and volatile components are not readily generated. The condensation temperature is preferably set in consideration of the composition ratio of the monomers. For example, because reaction readily progresses when the content ratio of bisphenol A alkylene oxide adduct in monomers is low, the content ratio of tri- or higher-basic carboxylic acid in monomers is low, or the ratio of the number of hydroxy groups to the number of carboxy groups in monomers is low, the condensation polymerization temperature can be set as low. The polyester resin constituting the composite particles has been described thus far.

(Disperse Dye Constituting Composite Particles)

The disperse dye constituting the composite particles is not particularly limited. The disperse dye has low hydrophilicity. However, by forming a composite from a polyester resin with a hydrophilic carboxy group and a hydrophilic hydroxy group, the composite particles containing the disperse dye can be favorably emulsion dispersed in the aqueous medium.

Furthermore, the disperse dye often has either or both a nitro group and a quinone structure. The nitro group and the quinone structure have high affinity to an ester bond in the polyester resin. As such, as the non-crystalline regions of the polyester resin soften and resin chain entanglement weakens along with an increase in temperature, the disperse dye easily permeates the non-crystalline regions along the resin chains. As such, the disperse dye can form a composite with the polyester resin through a simple method (e.g., a method by which the disperse dye and the polyester resin are kneaded without using a solvent or a dispersant).

Normally, textile printing on a cotton cloth is difficult using a disperse dye. However, because the composite particles adhere to a cotton cloth through the polyester resin in the composite particles, textile printing can be performed on the cotton cloth even when a disperse dye is used. Accordingly, textile printing becomes possible regardless of the type of textile printing target (e.g., cotton cloth or polyester cloth) even when a disperse dye is used.

Examples of the disperse dye include: C.I. Disperse Yellow 51, 54, or 60: C.I. Disperse Orange 5, 7, 20, or 23; C.I. Disperse Red 50, 53, 59, 60, 239, or 240: C.I. Disperse Violet 8, 11, 17, 26, 27, 28, or 36; C.I. Disperse Blue 3, 5, 26, 35, 55, 56, 72, 81, 91, 108, or 359: C.I. Disperse Yellow 42, 49, 76, 83, 88, 93, 99, 119, 126, 160, 163, 165, 180, 183, 186, 198, 199, 200, 224, or 237; C.I. Disperse Orange 29, 30, 31, 38, 42, 44, 45, 53, 54, 55, 71, 73, 80, 86, 96, 118, or 119; C.I. Disperse Red 73, 88, 91, 92, 111, 127, 131, 143, 145, 146, 152, 153, 154, 179, 191, 192, 206, 221, 258, 283, 302, 323, 328, or 359; C.I. Disperse Violet 26, 35, 48, 56, 77, or 97; and C.I. Disperse Blue 27, 54, 60, 73, 77, 79, 79:1, 87, 143, 165, 165:1, 165:2, 181, 185, 197, 225, 257, 266, 267, 281, 341, 353, 354, 358, 364, 365, 368, 359, or 360.

Note that a disperse dye toned to a black color by mixing disperse dyes in multiple colors may be used. For example, a disperse dye in which an orange disperse dye and a red disperse dye have been mixed with a blue disperse dye as a main component may be used as a black disperse dye. The hue may also be fine-tuned by further mixing disperse dyes other than orange and red disperse dyes into such a black disperse dye.

So as to be suitable for heat treatment in textile printing, the disperse dye is preferably a disperse dye suitable for thermal transfer. Preferable disperse dyes suitable for thermal transfer include C.I. Disperse Yellow 51, 54, or 60; C.I. Disperse Orange 5, 7, 20, or 23; C.I. Disperse Red 50, 53, 59, 60, 239, or 240; C.I. Disperse Violet 8, 11, 17, 26, 27, 28, or 36; and C.I. Disperse Blue 3, 5, 26, 35, 55, 56, 72, 81, 91, 108, or 359.

To inhibit unevenness in a textile-printed image, the disperse dye is preferably molecularly dispersed in the non-crystalline regions of the polyester resin in the composite particles. For the same purpose, preferably, the disperse dye is uniformly dispersed in the polyester resin in the composite particles. The non-crystalline regions of the polyester resin are easily dyed by the disperse dye. As such, by uniformly arranging the non-crystalline regions in the polyester resin, composite particles in which the disperse dye is uniformly dispersed in the polyester resin can be easily obtained.

The content ratio of the disperse dye is preferably at least 0.5% by mass and no greater than 10.0% by mass relative to the mass of the ink, more preferably at least 1.0% by mass and no greater than 7.0% by mass, and even more preferably at least 1.0% by mass and no greater than 4.0% by mass. By setting the content ratio of the disperse dye to at least 0.5% by mass relative to the mass of the ink, sufficient image density in a textile-printed image can be ensured. By setting the content ratio of the disperse dye to no greater than 10.0% by mass relative to the mass of the ink, sufficient chroma can be ensured in a textile-printed image.

To textile-print an image with sufficient image density, the content ratio of the disperse dye is preferably greater than 0% by mass and no greater than 50% by mass in the composite particles, and more preferably at least 1% by mass and no greater than 20% by mass.

<Cross-Linking Agent>

The cross-linking agent includes a blocked isocyanate. By cross-linking the composite particles with the textile printing target through the blocked isocyanate that is the cross-linking agent, the color fastness to rubbing of an image printed on the textile printing target can be still further improved. Note that a cross-linking reaction by the blocked isocyanate is described later in a third embodiment.

Here, an isocyanate is a compound with a —N═C═O group. The blocked isocyanate is an isocyanate in which the —N═C═O group that is reactive is encapsulated by a blocking agent. The —N═C═O group encapsulated by a blocking agent is represented by the chemical formula “—NHCOA”. A in the chemical formula “—NHCOA” represents a group derived from a blocking agent (AH). The blocked isocyanate is a compound having at least two (e.g., two) groups represented by the chemical formula “—NHCOA”.

A commercially available product can be used as the blocked isocyanate. Specific examples of the blocked isocyanate include MEIKANATE CX, SU-268A, NBP-873D, NBP-211, MEIKANATE TP-10, DM-6400, MEIKANATE DM-3031CONC, and MEIKANATE DM-350Z, products of Meisei Chemical Works. Ltd.

To improve the color fastness to rubbing of a textile-printed image, the blocked isocyanate is dispersed in the ink in the form of latex particles, for example. The content ratio of the blocked isocyanate is preferably at least 0.1% by mass and no greater than 10.0% by mass relative to the mass of the ink.

<Neutralizer>

Due to the ink containing a neutralizer, the carboxy group in the polyester resin in the composite particles is ionized and the composite particles are stably emulsion dispersed. Through ionization, the carboxy group (—COOH group) becomes a —COO group. Examples of the neutralizer include ammonia water, alkali aqueous solutions (e.g., a sodium hydroxide aqueous solution), allylamine, isopropylamine, diisopropylamine, ethylamine, diethylamine, triethylamine, 2-ethyl hexylamine, 3-ethoxypropylamine, diisobutylamine, 3-diethylaminopropylamine, tri-n-octylamine, t-butylamine, sec-butylamine, propylamine, methylaminopropylamine, dimethylaminopropylamine, n-propanolamine, butanolamine, 2-amino-4-pentanol, 2-amino-3-hexanol, 5-amino-4-octanol, 3-amino-3-methyl-2-butanol, monoethanolamine, N,N-dimethylethanolamine, isopropanolamine, neopentanolamine, diglycolamine, ethylene diamine, 1,3-diaminopropane, 1,2-diaminopropane, 1,6-diaminohexane, 1,9-diaminononane, 1,12-diaminododecane, dimeric fatty acid diamine, 2,2,4-trimethyl hexamethylene diamine, 2,4,4-trimethylhexamethylene diamine, hexamethylene diamine, N-aminoethylpiperazine, N-aminopropylpiperazine, N-aminopropyldipiperidinopropane, and piperazine. The neutralizer is preferably ammonia water or a sodium hydroxide aqueous solution.

The content of the neutralizer is preferably an amount sufficient for neutralizing the acid value of the polyester resin. The content of the neutralizer is not particularly limited, but preferably amounts to a value that results in the degree of neutralization of the polyester resin being at least 50%, and more preferably at least 60%. Note that the degree of neutralization is calculated from the formula: “degree of neutralization (%)=100−(number of moles of acid group after neutralization/number of moles of acid group before neutralization)×100”.

To stably emulsion disperse the composite particles, the content ratio of the neutralizer is preferably at least 0.1% by mass and no greater than 5.0% by mass relative to the mass of the ink.

<Aqueous Medium>

The aqueous medium is a medium containing water as a main component. The aqueous medium may function as a solvent or a dispersion medium. Specific examples of the aqueous medium include water or a liquid mixture of water and a hydrophilic organic solvent. Examples of the hydrophilic organic solvent contained in the aqueous medium include ketone solvents (specific examples include acetone), alcohol solvents (specific examples include methanol, ethanol, and isopropyl alcohol), and glycol ether solvents (specific examples include ethylene glycol monomethyl ether, ethylene glycol monobutyl ether, and ethylene glycol monotertiary butyl ether). The content ratio of the water is preferably at least 70% by mass in the aqueous medium, more preferably at least 80% by mass, and still more preferably at least 90% by mass.

The content ratio of the aqueous medium is preferably at least 5% by mass and no greater than 99% by mass relative to the mass of the ink, and more preferably at least 50% by mass and no greater than 90% by mass. By setting the content ratio of the aqueous medium to a value within such a range, an ink having an appropriate viscosity can be obtained.

<Surfactant>

The ink may contain a surfactant as necessary. The ink can have excellent wettability to a textile printing target as a result of containing a surfactant. Examples of the surfactant include anionic surfactants, cationic surfactants, nonionic surfactants, and zwitterionic surfactants.

The surfactant is preferably a nonionic surfactant, more preferably a surfactant with an acetylenic bond (e.g., a surfactant with an acetylene glycol structure), and even more preferably an ethylene oxide adduct of acetylenediol. The surfactant preferably has an HLB value of at least 1 and no greater than 5. The HLB value of the surfactant is calculated through the Griffin method from the formula. “HLB value=20×(total formula weight of hydrophilic moieties)/molecular weight”, for example.

The content ratio of the surfactant is preferably at least 0.01% by mass and no greater than 0.50% by mass relative to the mass of the ink. By setting the content ratio of the surfactant to within such a range, an ink having excellent dispersion stability for the composite particles is obtained. By setting the content ratio of the surfactant to no greater than 0.50% by mass, bubbles are not readily generated from the ink in the nozzles of a recording head included in an inkjet recording apparatus, and the ink can be stably ejected from the nozzles.

<Moisturizing Agent>

The ink may contain a moisturizing agent as necessary. If the ink contains a moisturizing agent, the liquid component can be inhibited from evaporating from the ink. Examples of the moisturizing agent include sorbitol, polyalkylene glycols, alkylene glycols, and glycerin. Examples of the polyalkylene glycols include polyethylene glycol and polypropylene glycol. Examples of the alkylene glycols include 3-methyl-1,5-pentanediol, ethylene glycol, propylene glycol, butylene glycol, diethylene glycol, dipropylene glycol, trimethylene glycol (i.e., 1,3-propanediol), triethylene glycol, tripropylene glycol, 1,2,6-hexanetriol, thiodiglycol, 1,3-butanediol, and 1,5-pentanediol. The moisturizing agent preferably includes either or both the alkylene glycols and glycerin, and more preferably either or both propylene glycol and glycerin. The content ratio of the moisturizing agent is preferably at least 0.1% by mass and no greater than 30.0% by mass relative to the mass of the ink, and more preferably at least 20.0% by mass and no greater than 30.0% by mass.

<Additive>

The ink may further contain an additive (specific examples include a viscosity modifier, a solution stabilizer, a penetrating agent, an antioxidant, and an ultraviolet absorbing agent) as necessary.

Note that the ink preferably does not contain a pigment. Due to the ink not containing a pigment which has a relatively large particle size, a textile print is inhibited from stiffening and the color fastness to rubbing can be improved. Furthermore, by a particulate pigment permeating into a textile printing target (e.g., into the gaps between the fibers in a cloth), image density can be inhibited from falling below a desired value and chroma can be inhibited from degrading.

### Second Embodiment: Ink Production Method

The following describes an ink production method according to a second embodiment of the present disclosure. The ink of the first embodiment is produced by the production method of the second embodiment. The ink production method of the second embodiment includes a kneading process, a composite particle formation process, and a mixing process.

(Kneading Process)

In the kneading process, the polyester resin and the disperse dye are kneaded to obtain a kneaded product. In the kneading, a kneader (specific examples include a single screw extruder and a twin screw extruder) is used, for example. The obtained kneaded product of the polyester resin and the disperse dye may be pulverized as necessary.

Note that instead of the kneading process, an alternative process (specific examples include a process in which the polyester resin and the disperse dye are mixed while being dissolved in a solution and a process by which monomers for forming the polyester resin is polymerized in a solution in which the monomers and the disperse dye are dissolved) may be performed. However, in the method of the kneading polyester resin and the disperse dye, it is more difficult for the disperse dye to separate and precipitate during phase inversion emulsification described below than in a method which implements an alternative process. Accordingly, it is preferable to implement the above kneading process.

(Composite Particle Formation Process)

In the composite particle formation process, the composite particles are formed by phase inversion emulsification of an oil phase and a water phase. The oil phase contains the kneaded product obtained through the kneading process and an organic solvent. The water phase contains water.

Specifically, the kneaded product, the organic solvent, and a neutralizer as necessary are charged into a reactor and the kneaded product is dissolved in the organic solvent to obtain the oil phase (organic solvent solution phase). The obtained oil phase contains the kneaded product, the organic solvent, and the neutralizer as necessary.

Next, water is added to the oil phase in the reactor to form the water phase. The water phase contains water. After the water is added, the oil phase becomes continuous and the water phase becomes a dispersion phase. That is, the liquid phase in the reactor becomes a liquid phase of a water-in-oil (W/O) emulsion in which the water phase is dispersed in droplet form in the oil phase.

Next, the oil phase and the water phase are stirred in the reactor, and the oil phase and the water phase undergo phase inversion emulsification. The stirring of the oil phase and the water phase is performed using a stirrer, for example. After the phase inversion emulsification, the water phase becomes continuous and the oil phase becomes dispersed. That is, the liquid phase in the reactor becomes a liquid phase of an oil-in-water (O/W) emulsion in which the oil phase is dispersed in droplet form in the water phase. The oil phase in droplet form becomes the emulsified composite particles. The organic solvent in the oil phase is distilled under reduced pressure as necessary and a water dispersion of the composite particles is obtained.

The organic solvent contained in the oil phase is preferably a solvent with a ketone structure, more preferably acetone, methyl ethyl ketone, diethyl ketone, dipropyl ketone, methyl isobutyl ketone, or methyl isopropyl ketone, and particularly preferably methyl ethyl ketone. By using such an organic solvent, the kneaded product can be easily dissolved in the organic solvent and the organic solvent can be easily distilled after phase inversion emulsification.

Before the water phase is added to the oil phase in the composite particle formation process, the neutralizer is preferably added to the oil phase to ionize the carboxy group in the polyester resin contained in the kneaded product. By ionizing the carboxy group, the affinity between the polyester resin in the oil phase and the water phase is increased and the phase inversion emulsification can proceed favorably. The temperature of the oil phase when adding the neutralizer is preferably a temperature no higher than the boiling point of the organic solvent, and more preferably no higher than 75° C. Note that when the phase inversion emulsification proceeds without problems, the addition of the neutralizer can be omitted.

The content ratio of the kneaded product is preferably at least 5% by mass and no greater than 70% by mass in the oil phase before the water phase is added, more preferably at least 10% by mass and no greater than 60% by mass, and even more preferably at least 10% by mass and no greater than 50% by mass. By setting the content ratio of the kneaded product to a value within such a range, the particle size of the composite particles formed from the kneaded product can be easily controlled and the composite particles can be more efficiently produced.

The temperature of the water phase and the oil phase is preferably the glass transition point of the polyester resin or higher. By setting the temperature to the glass transition point or higher, the non-crystalline regions in the polyester resin in the kneaded product are softened, the entanglement of the resin chains is weakened, and the disperse dye further permeates into the non-crystalline regions along the resin chains. As a result, the compatibility of the disperse dye with the polyester resin in the kneaded product is further increased.

Note that whether or not the disperse dye has been introduced to the polyester resin can be confirmed by the following method. That is, after the composite particles are formed, the aqueous medium containing the composite particles is sampled. The aqueous medium containing the composite particles is centrifuged for 30 minutes at a rotational speed of 15,000 rpm using a centrifuge. After centrifugation, supernatant is collected. The disperse dye contained in the supernatant is quantified by an absorbance method using a spectrophotometer (e.g., product of Hitachi, Ltd.). The amount of the disperse dye contained in the supernatant corresponds to the amount of the disperse dye not introduced to the polyester resin.

(Mixing Process)

In the mixing process, the composite particles, the aqueous medium, and the cross-linking agent are mixed. A stirrer is used for mixing, for example. Note that additional ink components (specifically, at least one component selected from the group consisting of a surfactant, a moisturizing agent, and an additive) may be further added and mixed as necessary. The obtained mixture is filtered as necessary. As a result, an ink is obtained. The ink production method of the second embodiment has been described thus far.

### Third Embodiment: Inkjet Textile Printing Method

A third embodiment of the present disclosure relates to an inkjet textile printing method. The inkjet textile printing method of the third embodiment includes ejecting, for example. In the ejecting, an ink is ejected from an ejection surface of a recording head onto a textile printing target. The ejected ink is the ink of the first embodiment.

To improve the color fastness to rubbing of a textile-printed image, preferably, the inkjet textile printing method of the third embodiment further includes heating in addition to the ejecting. In the heating, the ink having landed on the textile printing target is heated.

In the inkjet textile printing method of the third embodiment, the ink of the first embodiment is used. As previously described, the ink of the first embodiment has excellent dispersibility and preservation stability. Accordingly, the inkjet textile printing method of the third embodiment which uses such an ink can inhibit ink agglomeration in an inkjet printing apparatus. As also previously described, an image with few image defects and excellent color fastness to rubbing can be textile-printed with the ink of the first embodiment, and can tactile degradation of a textile print formed with the ink can be inhibited. Accordingly, the inkjet textile printing method of the third embodiment which uses such an ink can achieve textile printing of an image with few image defects and excellent color fastness to rubbing, and can inhibit tactile degradation of a textile print.

The inkjet textile printing method of the third embodiment also has the following advantages over sublimation textile printing: the molecular weight of the disperse dye used is not limited because sublimation transfer need not be performed in a short time; and residual disperse dye on transfer paper is not generated because transfer paper is not used. Note that sublimation textile printing refers to a method in which sublimation dye in an ink is transferred from transfer paper to a textile printing target by applying heat after the ink is ejected onto the transfer paper using an inkjet textile printing apparatus.

The inkjet textile printing method of the third embodiment also has the following advantages over the use of an ink containing an uncomposited disperse dye: bleeding does not readily occur in a disperse dye spread by capillary action along the fibers of a textile printing target and an image with clear edges can be formed; and post-treatment to wash away unfixed disperse dye is not necessary.

The following describes specific examples of the inkjet textile printing method of the third embodiment with reference to FIGURE. FIGURE illustrates an example of an inkjet textile printing apparatus used in the inkjet textile printing method of the third embodiment.

An inkjet textile printing apparatus 10 illustrated in FIGURE includes a feeder 11, an ink ejecting section 12, a dryer 14, a heat treatment section 15, and a collecting section 17. A textile printing target P1 is set in the inkjet textile printing apparatus 10. In FIGURE, the textile printing target before textile printing of an image is completed is indicated as the textile printing target P1, and the textile printing target after the textile printing of an image is completed is indicated as a textile print P2. The feeder 11, the ink ejecting section 12, the dryer 14, the heat treatment section 15, and the collecting section 17 are arranged in a conveyance direction of the textile printing target P1 in the stated order.

The feeder 11 feeds the textile printing target P1 to the ink ejecting section 12.

The ink ejecting section 12 ejects the ink onto the textile printing target P1 fed from the feeder 11. The ink ejecting section 12 includes a recording head 13. The ink is ejected from the recording head 13 (specifically, an ejection surface of the recording head 13) onto the textile printing target P1 (specifically, an image formation area of the textile printing target P1). The recording head 13 is not particularly limited, but examples thereof include a piezoelectric inkjet head and a thermal inkjet head.

The dryer 14 dries the ink ejected onto the textile printing target P1.

The heat treatment section 15 performs heat treatment on the ink ejected onto the textile printing target P1. The heat treatment section 15 includes a heating roller 16a and a pressure roller 16b. The heating roller 16a includes an internal heating element and applies heat to the textile printing target P1. The pressure roller 16b is pressed against the heating roller 16a with the textile printing target P1 therebetween.

The collecting section 17 rolls up and collects the textile printing target P1 having been subjected to heat treatment and textile printing, that is, the textile print P2. One edge of the textile printing target P1 is set in the feeder 11, and the other edge of the textile printing target P1 is set in the collecting section 17. As such, by the collecting section 17 rolling up and collecting the textile printing target P1, another textile printing target P1 is conjunctively fed from the feeder 11.

The textile printing target P1 may be a woven or knitted fabric. Examples of the textile printing target P1 include cotton fabric, silk fabric, hemp fabric, acetate fabric, rayon fabric, nylon fabric, polyurethane fabric, and polyester fabric.

The method by which an image is printed on the textile printing target Pt using the inkjet textile printing apparatus 10 illustrated in FIGURE is described. First, the feeder 11 feeds the textile printing target P1 housed therein to the ink ejecting section 12.

Next, the ejecting is performed. In the ejecting, upon the image formation area of the textile printing target P1 reaching a position opposite to the recording head 13 included in the ink ejecting section 12, the ink is ejected from the recording head 13 (specifically, the openings of nozzles formed on the ejection surface of the recording head 13) onto the textile printing target P1.

Next, drying is performed as necessary. In the drying, the dryer 14 dries the area of the textile printing target P1 where the ink has landed. The drying temperature of the dryer 14 is lower than the later-described heat treatment temperature of the heat treatment section 15, for example. The drying temperature of the dryer 14 is lower than a cross-linking temperature, for example. The cross-linking temperature is a temperature at which the cross-linking agent cross-links the hydroxy group in the textile printing target P1 and the hydroxy group in the polyester resin contained in the composite particles. By performing the drying, the ink on the textile printing target P1 can be dried to the extent that the ink does not attach to the pressure roller 16b in the later-described heating.

Next, the heating is performed. In the heating, the ink having landed on the textile printing target P1 is heated. Specifically, the area of the textile printing target P1 where the ink has landed passes through a nip part formed by the heating roller 16a and the pressure roller 16b. At this time, heat and pressure are applied to the textile printing target P1 on which the ink has landed.

The heating temperature of the heat treatment section 15 is higher than the cross-linking temperature, for example. The heating temperature of the heat treatment section 15 is at least 120° C. and no higher than 200° C., for example. The heating time is at least 1 minute and no longer than 10 minutes, for example.

By heating the ink on the textile printing target P1 at a temperature higher than the cross-linking temperature, the cross-linking agent causes a cross-linking reaction. Specifically, the textile printing target P1 has a hydroxy group, for example. The polyester resin contained in the composite particles in the ink also has a hydroxy group. By applying heat to the ink, the cross-linking agent (blocked isocyanate) cross-links the hydroxy group in the textile printing target P1 and the hydroxy group in the polyester resin contained in the composite particles in the ink. As a result, the composite particles adhere to the textile printing target P1 through the cross-linking agent.

In the following, the cross-linking reaction by the blocked isocyanate which is a cross-linking agent is described in detail. As described in the first embodiment, the blocked isocyanate is a compound having at least 2 (e.g., 2) groups represented by the chemical formula “—NHCOA”. In the ink yet to be heated, the —NHCOA group does not react with the hydroxy groups because the —NHCO group is encapsulated by a group A derived from a blocking agent. However, once the ink is heated, the group A derived from a blocking agent separates from the —NHCOA group and forms a reactive —N═C═O group to react with the hydroxy group (—OH). Specifically, a reaction represented by the chemical equation “—OH+—NHCOA→—OH+—N═C═O+AH→—OCONH—+AH” proceeds. As a result, cross-linking structures represented by the chemical formula “—OCONH—” are formed and the blocking agent (AH) separates. A portion of the —N═C═O group of the blocked isocyanate formed by heating reacts with the hydroxy group in the textile printing target P1. Through this reaction, the hydroxy group in the textile printing target P1 and the blocked isocyanate are bonded through the cross-linking structures (—OCONH—). The remainder of the —N═C═O group reacts with the hydroxy group in the polyester resin contained in the composite particles in the ink. Through this reaction, the hydroxy group in the polyester resin contained in the composite particles in the ink is bonded with the blocked isocyanate through the cross-linking structures (—OCONH—). In this manner, the textile printing target P1 and the composite particles are bonded through the blocked isocyanate which is a cross-linking agent and two cross-linking structures. As a result, the disperse dye contained in the composite particles does not readily separate from the textile printing target P1 and the color fastness to rubbing of a textile-printed image is improved. The cross-linking reaction by the blocked isocyanate as the cross-linking agent has been described thus far.

Due to the heat treatment section 15 applying heat to the ink on the textile printing target P1, advantages can be obtained other than the above-described cross-linking reaction. For example, when the textile printing target P1 is a polyester fiber cloth formed of polyester resin with non-crystalline regions, a portion of the disperse dye contained in the composite particles in the ink is moved to the non-crystalline regions of the polyester resin of the polyester fiber cloth due to the heat treatment section 15 applying heat to the ink on the textile printing target P1. Thus, the disperse dye can be integrated with the polyester fiber cloth.

By performing the heating, the textile printing target P1 with an image textile-printed thereon, that is, the textile print P2, is formed. The textile print P2 is rolled up and collected by the collecting section 17.

An example of the inkjet textile printing method of the third embodiment has been described thus far using FIGURE. However, the inkjet textile printing method of the third embodiment is not limited to the above method, and may for example be altered as in the following first to eighth variations. With respect to the first variation, pretreatment may be performed on the textile printing target P1 before the ink is ejected onto the textile printing target P1. By performing the pretreatment, a textile-printed image can be inhibited from bleeding, and an image can be textile-printed with high color developability and sharpness. With respect to the second variation, the drying may be omitted when an image can be favorably textile-printed. With respect to the third variation, the heating may be omitted when an image with desired color fastness to rubbing can be textile-printed. With respect to the fourth variation, a drying apparatus or a steam heating apparatus which blows hot air onto the textile printing target P1 may be used instead of the heat treatment section 15 which includes the heating roller 16a and the pressure roller 16b. With respect to the fifth variation, the heat treatment section 15 may not be provided inside the inkjet textile printing apparatus 10. For example, after an image is textile-printed on the textile printing target P1 using the inkjet textile printing apparatus 10, the textile printing target P1 on which the ink has landed may be heated using a heating apparatus independent of the inkjet textile printing apparatus 10 (i.e., separate from the inkjet textile printing apparatus 10). With respect to the sixth variation, metal ion treatment, acid treatment, or alkali treatment may be further performed on the textile print P2 on which an image has been textile-printed to improve the color fastness of the textile-printed image. With respect to the seventh variation, the ink ejecting section 12 included one recording head 13, but may include a plurality of recording heads 13. With respect to the eighth variation, a flatbed inkjet textile printing apparatus may be used instead of the inkjet textile printing apparatus 10. Regardless of the type of inkjet textile printing apparatus, the effects of the present disclosure can be achieved using the ink of the first embodiment.

### EXAMPLES

The following describes Examples of the present disclosure. Note that in evaluations in which errors might occur, an evaluation value was calculated by obtaining an appropriate number of measured values and calculating the arithmetic mean of the measured values in order to ensure that any errors were sufficiently small. In the following description, “parts by mass” may be referred to as “parts”.

[Polyester Resin Preparation]

Non-crystalline resins (A1) to (A6) and (B1) to (B9) and a crystalline polyester resin (B10) (respectively referred to in the following as resins (A1) to (A6) and (B1) to (B10)) were prepared. Monomers used for the production of the resins (A1) to (A6) and (B1) to (B9) are shown in Table 1. Furthermore, the amount by mass (unit: mol) of the repeating units, the content ratios of the repeating units, the glass transition points, the acid values, and the hydroxyl values of the resins (A1) to (A6) and (B1) to (B9) are shown in Tables 2 and 3. Note that the resin (B10) is described later.

TABLE 1

| Resin | | | A1 | A2 | A3 | A4 | A5 | A6 | B1 | B2 | B3 | B4 | B5 | B6 | B7 | B8 | B9 |
|---|---|---|---|---|---|---|---|---|---|---|---|---|---|---|---|---|---|
| Monomer | Tereplithalic acid | [parts] | 60 | 58 | 55 | 58 | — | 48 | 58 | 55 | 30 | 58 | 58 | 48 | 53 | 100 | 55 |
| amount | Isophthalic acid | [parts] | 39 | 38 | 34 | 41 | 41 | 41 | 41 | 45 | 28 | 32 | 42 | 16 | 45 | — | 45 |
| | Trimellitic acid | [parts] | — | 2 | 6 | 1 | 1 | — | 1 | — | 2 | 8 | — | 1 | 1 | — | — |
| | Pyromellitic acid | [parts] | 1 | — | — | — | — | 1 | — | — | — | 5 | — | — | 1 | — | — |
| | NDC | [parts] | — | — | — | — | 58 | — | — | — | 40 | — | — | — | — | — | — |
| | SSW | [parts] | — | 2 | — | — | — | 10 | — | — | — | — | — | 25 | — | — | — |
| | EG | [parts] | 33 | 28 | 30 | 25 | 33 | 30 | 78 | 33 | 15 | 33 | 22 | 33 | 33 | 33 | 100 |
| | BPA-PO | [parts] | 63 | 70 | 65 | 65 | 63 | 68 | 20 | 65 | 83 | 65 | 63 | 63 | 65 | 65 | — |
| | Diethylene glycol | [parts] | 2 | — | 7 | 5 | 2 | — | — | 2 | — | — | 5 | 2 | 2 | — | — |
| | Pentaerythritol | [parts] | — | — | 2 | 6 | — | 1 | — | — | — | — | 6 | 2 | — | 2 | — |
| | Trimethylolpropane | [parts] | 2 | 1 | — | — | 2 | 1 | 2 | — | 2 | 2 | — | — | — | — | — |
| | Glycerin | [parts] | — | 1 | — | — | — | — | — | — | — | — | 4 | — | — | — | — |

TABLE 2

| Resin | | | A1 | A2 | A3 | A4 | A5 | A6 |
|---|---|---|---|---|---|---|---|---|
| Repeating | Terephthalic acid | [mol] | 0.361 | 0.349 | 0.331 | 0.349 | — | 0.289 |
| unit | Isophthalic acid | [mol] | 0.235 | 0.229 | 0.205 | 0.247 | 0.247 | 0.247 |
| amount | Trimellitic acid | [mol] | — | 0.010 | 0.029 | 0.005 | 0.005 | — |
| | Pyromellitic acid | [mol] | 0.004 | — | — | — | — | 0.004 |
| | NDC | [mol] | — | — | — | — | 0.237 | — |
| | SSIP | [mol] | — | 0.007 | — | — | — | 0.037 |
| | EG | [mol] | 0.532 | 0.4:31 | 0.483 | 0.403 | 0.532 | 0.483 |
| | BPA-PO | [mol] | 0.183 | 0.204 | 0.189 | 0.189 | 0.183 | 0.198 |
| | Diethylene glycol | [mol] | 0.019 | — | 0.019 | 0.047 | 0.019 | — |
| | Pentaerythritol | [mol] | — | — | 0.015 | 0.044 | — | 0.007 |
| | Trimethylolpropane | [mol] | 0.015 | 0.007 | — | — | 0.015 | 0.007 |
| | Glycerin | [mol] | — | 0.011 | — | — | — | — |

| | | | | | | | |
|---|---|---|---|---|---|---|---|
| 3 ≤ -basic carboxylic acid ratio | [mol %] | 0.7 | 1.6 | 5.1 | 0.8 | 1.0 | 0.7 |
| 3 ≤ -hydric alcohol ratio | [mol %] | 2.0 | 2.7 | 2.1 | 6.5 | 2.0 | 2.1 |
| EG ratio | [mol %] | 71.0 | 67.0 | 68.5 | 59.0 | 71.0 | 69.5 |
| Sulfonic acid unit ratio | [mol %] | 0.0 | 1.3 | 0.0 | 0.0 | 0.0 | 6.5 |
| Aromatic ratio | [mol %] | 88.1 | 63.0 | 59.3 | 61.5 | 54.3 | 60.9 |
| Tg | [° C.] | 50 | 72 | 55 | 53 | 58 | 65 |
| Acid value | [mgKOH/g] | 12 | 30 | 65 | 21 | 16 | 14 |
| Hydroxyl value | [mgKOR/g] | 22 | 23 | 21 | 56 | 21 | 21 |

TABLE 3

| Resin | | | B1 | B2 | B3 | B4 | B5 | B6 | B7 | B8 | B9 |
|---|---|---|---|---|---|---|---|---|---|---|---|
| Reapting | Terephthalic acid | [mol] | 0.349 | 0.331 | 0.181 | 0.349 | 0.349 | 0.289 | 0.319 | 0.602 | 0.331 |
| unit | Isophthalic acid | [mol] | 0.247 | 0.271 | 0.169 | 0.193 | 0.253 | 0.096 | 0.271 | — | 0.271 |
| amount | Trimeilitic acid | [mol] | 0.005 | — | 0.010 | 0.038 | — | 0.005 | 0.005 | — | — |
| | Pyro ellitic acid | [mol] | — | — | — | 0.020 | — | — | 0.004 | — | — |
| | NDC | [mol] | — | — | 0.164 | — | — | — | — | — | — |
| | SSIP | [mol] | — | — | — | — | — | 0.093 | — | — | — |
| | EG | [mol] | 1.257 | 0.532 | 0.242 | 0.532 | 0.354 | 0.532 | 0.532 | 0.532 | 1.611 |
| | BPA-PO | [mol] | 0.058 | 0.189 | 0.241 | 0.189 | 0.183 | 0.183 | 0.189 | 0.189 | — |
| | Diethylene glycol | [mol] | — | 0.019 | — | — | 0.047 | 0.019 | 0.019 | — | — |
| | Pentaerythritol | [mol] | — | — | — | — | 0.044 | 0.015 | — | 0.015 | — |
| | Trimethylolpropane | [mol] | 0.015 | — | 0.015 | 0.015 | — | — | — | — | — |
| | Glycerin | [mol] | — | — | — | — | 0.043 | — | — | — | — |

| | | | | | | | | | | |
|---|---|---|---|---|---|---|---|---|---|---|
| 3 ≤ -basic carboxylic acid ratio | [mol %] | 0.8 | 0.0 | 1.8 | 9.6 | 0.0 | 1.0 | 1.5 | 0.0 | 0.0 |
| 3 ≤ -hydric alcohol ratio | [mol %] | 1.1 | 0.0 | 3.0 | 2.0 | 13.0 | 2.0 | 0.0 | 2.0 | 0.0 |
| EG ratio | [mol %] | 94.5 | 71.9 | 48.5 | 72.3 | 52.7 | 71.0 | 71.9 | 72.3 | 100.0 |
| Sulfonic acid unit ratio | [mol %] | 0.0 | 0.0 | 0.0 | 0.0 | 0.0 | 19.3 | 0.0 | 0.0 | 0.0 |
| Aromatic ratio | [mol %] | 34.1 | 59.0 | 74.9 | 59.1 | 61.6 | 54,1 | 58.9 | 59.1 | 27.2 |
| Tg | [° C.] | 40 | 55 | 80 | 50 | 52 | 50 | 54 | 56 | 35 |
| Acid value | [mgKOH/g] | 20 | 5 | 17 | 75 | 11 | 11 | 17 | 4 | 4 |
| Hydroxyl value | [mgKOH/g] | 21 | 10 | 22 | 20 | 70 | 21 | 8 | 20 | 5 |

The monomer names in the row titled “Monomer amount” in Table 1 refer to the monomers used in production of the resins. By contrast, the monomer names in the row titled “Repeating unit amount” in Tables 2 and 3 refer to repeating units derived from the corresponding monomers. For example, “Terephthalic acid” in Table 1 refers to terephthalic acid, and “Terephthalic acid” in Tables 2 and 3 refers to a repeating unit derived from terephthalic acid.

The meanings of the terms listed in Tables 1 to 3 other than that described above are as follows.

Monomer amount: a mass (unit: part) of the corresponding monomer used to produce a resin.

Repeating unit amount: an amount by mass (unit: mol) of the corresponding repeating unit in a resin.

NDC: dimethyl 2,6-naphthalenedicarboxylate.

SSIP: sodium 5-sulfoisophthalate.

EG: ethylene glycol.

BPA-PO: 2-molar propylene oxide adduct of bisphenol A.

−: no corresponding monomer is added, or no corresponding repeating unit is included.

Tg: glass transition point (unit: ° C.).

Next, the calculation method for each of the content ratios of the repeating units shown in Tables 2 and 3 is described. Note that in the later described calculation method, the terms M1 to M12 are defined as follows.

M1: amount (unit: mol) of repeating unit derived from terephthalic acid.

M2: amount (unit: mol) of repeating unit derived from isophthalic acid.

M3 amount (unit: mol) of repeating unit derived from trimellitic acid.

M4: amount (unit: mol) of repeating unit derived from pyromellitic acid.

M5: amount (unit: mol) of repeating unit derived from dimethyl 2,6-naphthalenedicarboxylate.

M6: amount (unit: mol) of repeating unit derived from sodium 5-sulfoisophthalate.

M7: amount (unit: mol) of repeating unit derived from ethylene glycol.

M8: amount (unit: mol) of repeating unit derived from 2-molar propylene oxide adduct of bisphenol A.

M9: amount (unit: mol) of repeating unit derived from diethylene glycol.

M10: amount (unit: mol) of repeating unit derived from pentaerythritol.

M11: amount (unit: mol) of repeating unit derived from trimethylolpropane.

M12: amount (unit: mol) of repeating unit derived from glycerin.

The tri- or higher-basic carboxylic acid ratio was calculated from the calculation formula “(tri- or higher-basic carboxylic acid ratio)=100×(amount of third repeating unit derived from tri- or higher-basic carboxylic acid)/(total amount of repeating units derived from polybasic carboxylic acid)=100×(M3+M4)/(M1+M2+M3+M4+M5+M6)”.

The tri- or higher-hydric alcohol ratio was calculated from the calculation formula “(tri- or higher-hydric alcohol ratio)=100×(amount of first repeating unit derived from tri- or higher-hydric alcohol)/(total amount of repeating units derived from polyhydric alcohol)=100×(M10+M11+M12)/(M7+M8+M9+M10+M11+M12)”.

The EG ratio was calculated from the calculation formula “(EG ratio)=100×(amount of second repeating unit derived from ethylene glycol)/(total amount of repeating units derived from polyhydric alcohol)=100×(M7)/(M7+M8+M9+M10+M 1I+M12)”.

The sulfonic acid unit ratio was calculated from the calculation formula “(sulfonic acid unit ratio)=100×(amount of fourth repeating unit derived from polybasic carboxylic acid with sulfonic acid group)/(total amount of repeating units derived from polybasic carboxylic acid)=100×(M6)/(M1+M2+M3+M4+M5+M6)”.

The aromatic ratio was calculated from the calculation formula “(aromatic ratio)=100×[(amount of fifth repeating unit derived from polybasic carboxylic acid with aromatic hydrocarbon)+(amount of sixth repeating unit derived from polyhydric alcohol with aromatic hydrocarbon)]/[(total amount of repeating units derived from polybasic carboxylic acid)+(total amount of repeating units derived from polyhydric alcohol)]=100×[(M1+M2+M3+M4+M5+M6)+(M8)]/[(M1+M2+M3+M4+M5+M6)+(M7+M8+M9+M10+M11+M12]”. Next, the preparation methods of the resins are described.

<Preparation of Resin (A1)>

A four-necked flask equipped with a distillation tube, a nitrogen inlet tube, a thermometer, and a stirring impeller was prepared. The flask was filled with terephthalic acid (60 parts), isophthalic acid (39 parts), pyromellitic acid (1 part), ethylene glycol (33 parts), 2-molar propylene oxide adduct of bisphenol A (63 parts), diethylene glycol (2 parts), and trimethylolpropane (2 parts) as monomers, and tetrabutoxytitanium (0.1 part) as a reaction catalyst. The flask contents were heated to 130° C. In addition, the flask contents were raised in temperature from 130° C. to 170° C. over 2 hours. In addition, pressure on the flask contents was gradually decreased from normal pressure to 5 mmHg while gradually increasing the temperature of the flask contents from 170° C. to 250° C. Condensation polymerization of the monomers was caused in the flask under a temperature of 250° C. and a reduced pressure of 5 mmHg to obtain a resin (A1).

<Preparation of Resins (A2) to (A6) and (B1) to (B9)>

Resins (A2) to (A6) and (B1) to (B9) were prepared by the same method as that for the resin (A1) in all aspects other than that the monomers shown in Table 1 were used in the respective amounts (unit: part) shown in Table 1.

<Resin (B10) Preparation>

A four-necked flask with a 5 L capacity equipped with a nitrogen inlet tube, a drainage tube, a stirrer, and a thermocouple was prepared. The flask was filled with 1,4-butanediol (25.00 moles), fumaric acid (23.75 moles), trimellitic anhydride (1.65 moles), and hydroquinon (5.3 g), and the flask contents were allowed to react for 5 hours at 160° C. Next, the internal temperature of the flask was raised to 200° C. and the flask contents were allowed to react for 1 hour at 200° C. Next, the internal pressure of the flask was decreased to 8.3 KPa and the flask contents were allowed to react for 1 hour at 200° C. A resin (B10) was obtained in this manner. The resin (B10) had an acid value of 24 mgKOH/g and a hydroxyl value of 28 mgKOH/g.

<Glass Transition Point and Melting Point Measurement>

The glass transition points and the melting points of the obtained resins (A1) to (A6) and (B1) to (B10) were measured in accordance with Japanese Industrial Standard (JIS) K7121-2012 using a differential scanning calorimeter (“DSC-60”, product of Shimadzu Corporation).

The results of measurement of the glass transition points of the resins (A1) to (A6) and (B1) to (B9) are shown above in Tables 2 and 3. The resins (A1) to (A6) and (B1) to (B9) did not have clear melting points as clear melting peaks were not confirmed in heat absorption curves thereof. The resins (A1) to (A6) and (B1) to (B9) all had glass transition points but no clear melting points, and were therefore determined to be non-crystalline polyester resins.

By contrast, the resin (B10) had a glass transition point of 45° C. and a melting point of 130° C. Due to having a glass transition point and a melting point, the resin (B10) was determined to be a crystalline polyester resin.

<Acid Value and Hydroxyl Value Measurement>

The acid values and hydroxyl values of the resins (A1) to (A6) and (B1) to (B9) were measured according to Japanese Industrial Standard (JIS) K0070-1992 using an automatic titrator (“Automatic Titrator COM-2500”, product of HIRANUMA SANGYO Co., Ltd.).

The measurement results of the acid values and hydroxyl values of the resins (A1) to (A6) and (B1) to (B9) are shown above in Tables 2 and 3. Note that the resin (B10) was confirmed to be a crystalline polyester resin corresponding to a resin in a comparative example, and therefore an acid value and hydroxyl value thereof was not measured.

[Colored Resin Preparation]

Next, colored resins (C1) to (C6) and (D1) to (D10) were prepared. The compositions of these colored resins are shown in Tables 4 and 5.

TABLE 4

| | | | | | | |
|---|---|---|---|---|---|---|
| Colored | C1 | C2 | C3 | C4 | C5 | C6 |
| resin | | | | | | |
| Resin | A1 | A2 | A3 | A4 | A5 | A6 |
| | (non-crystalline) | (non-crystalline) | (non-crystalline) | (non-crystalline) | (non-crystalline) | (non-crystalline) |
| Disperse dye | D.B. 359 | D.R. 60 | D.B. 60 | D.Y. 54 | D.R. 60 | D.B. 359 |

TABLE 5

| | | | | | | | | | | |
|---|---|---|---|---|---|---|---|---|---|---|
| Colored | D1 | D2 | D3 | D4 | D5 | D6 | D7 | D8 | D9 | D10 |
| resin | | | | | | | | | | |
| Resin | B1 | B2 | B3 | B4 | B5 | B6 | B7 | B8 | B9 | B10 |
| | (non- | (non- | (non- | (non- | (non- | (non- | (non- | (non- | (non- | (non- |
| | crystalline) | crystalline) | crystalline) | crystalline) | crystalline) | crystalline) | crystalline) | crystalline) | crystalline) | crystalline) |
| Disperse dye | D.R. 60 | D.B. 359 | D.B. 359 | D.B. 359 | D.B. 359 | D.R. 60 | D.R. 60 | D.R. 60 | D.R. 60 | D.B. 60 |

The terms in Tables 4 and 5 are defined as follows.

D.B. 359: C.I. Disperse Blue 359.

D.B. 60: C.I. Disperse Blue 60.

D.R. 60: C.I. Disperse Red 60.

D.Y. 54: C.I. Disperse Yellow 54.

(non-crystalline): corresponding resin was a non-crystalline resin.

(crystalline): corresponding resin was a crystalline resin.

<Preparation of Colored Resin (C1)>

The resin (A1) (100 parts) was mixed with C.I. Disperse Blue 359 (10 parts) using an FM mixer (product of Nippon Coke & Engineering Co., Ltd.) to obtain a mixture. The mixture was kneaded using a twin screw extruder (“PCM-30”, product of ikegai Corp.) and the colored resin (C1) being the kneaded product was obtained.

<Preparation of Colored Resins (C2) to (C6) and (D1) to (D10)>

The colored resins (C2) to (C6) and (D1) to (D10) were prepared by the same method as that for the colored resin (C1) in all aspects other than that the resins and the disperse dyes shown in Tables 4 and 5 were used.

[Composite Particle Dispersion Preparation]

Next, composite particle dispersions (D-C1) to (D-C6) and (D-D1) to (D-D10) were prepared. The colored resins used in the preparation of these dispersions are shown in the row titled “Colored resin” of later described Tables 6 and 7.

<Preparation of Dispersion (D-C1)>

A double-necked flask equipped with a stirrer and a thermocouple was filled with the colored resin (C1) (100 g) and methyl ethyl ketone (100 g). The flask contents were heated 25 to 70° C. and the colored resin was dissolved in the methyl ethyl ketone to obtain a solution. Another flask was filled with the obtained solution (40 g) and a neutralizer (IN sodium hydroxide aqueous solution, 5 g) and the carboxy group of the colored resin (C1) was ionized. A liquid mixture of water (residual amount) and methyl ethyl ketone (40 g) was added into the flask, and the flask contents were thoroughly stirred. Note that “residual amount” refers to an amount of water resulting in a solid concentration of 10% by mass of the dispersion after the distillation of methyl ethyl ketone under reduced pressure. In this manner, phase inversion emulsification proceeded and emulsified composite particles of the colored resin (C1) were formed. Next, the methyl ethyl ketone was distilled under reduced pressure from the flask contents at a temperature of 30° C. Through the distillation under reduced pressure, a dispersion (D-C1) being an aqueous dispersion of the composite particles was obtained.

<Preparation of Dispersions (D-C2) to (D-C6), (D-D1) to (D-D5), and (D-D7) to (D-D10)>

Dispersions (D-C2) to (D-C6), (D-D1) to (D-D5), and (D-D7) to (D-D10) were prepared by the same method as that for the dispersion (D-C1) in all aspects other than that the colored resins shown in Tables 6 and 7 were used and a IN sodium hydroxide aqueous solution was added in the amounts shown in Tables 6 and 7.

Note that a colored resin is micronized through phase inversion emulsification to form composite particles. As such, for the composite particles contained in the dispersions (D-C1) to (D-C6), (D-D1) to (D-D5), and (D-D7) to (D-D10), the polyester resin ratios in the composite particles were calculated as 91% by mass from the formula “(polyester resin ratio)=100×(mass of polyester resin)/[(mass of colored resin)]=100×(mass of polyester resin)/[(mass of polyester resin)+(mass of disperse dye)]=100×100/(100+10)”.

<Attempt to Prepare Dispersion (D-D6)>

An attempt was made to prepare a dispersion (D-D6) using the same method as that for the dispersion (D-C1) in all aspects other than that the colored resin (D6) shown in Table 7 was used and a IN sodium hydroxide aqueous solution was added in the amount shown in Table 7. However, the colored resin (D6) dissolved in the water phase during phase inversion emulsification and the phase inversion emulsification did not proceed. As such, composite particles being emulsified particles did not form and the dispersion (D-D6) was not able to be prepared.

[Ink Preparation]

Next, inks (IA-1) to (IA-7), (IB-1) to (IB-5), and (IB-7) to (IB-11) were prepared. The compositions of these inks are shown in later-described Tables 6 and 7. Note that because the dispersion (D-D6) was not able to be prepared as previously described, an ink (IB-6) was not prepared.

<Preparation of Ink (I-A1)>

The dispersion (D-C1) (20.0 g, solid concentration: 10% by mass), propylene glycol (4.0 g), glycerin (4.0 g), a surfactant (“SURFYNOL (registered Japanese trademark) 104PG-50”, product of Nissin Chemical Industry Co., Ltd, 0.1 g), and a cross-linking agent (blocked isocyanate, “MEIKANATE CX”, product of Meisei Chemical Works, Ltd., 1.0 g) were stirred using a stirrer to obtain a liquid mixture. The liquid mixture was filtered using a filter with a 5 μm pore size to obtain the ink (IA-1).

<Preparation of Inks (IA-2) to (IA-7), (IB-1) to (IB-5), and (IB-7) to (IB-11)>

The inks (IA-2) to (IA-7), (IB-1) to (IB-5), and (IB-7) to (IB-11) were prepared by the same method as that for the ink (IA-1) in all aspects other than that the dispersions shown in Tables 6 and 7 were used and the cross-linking agents shown in Tables 6 and 7 were used in the amounts shown in Tables 6 and 7.

<D₅₀ Measurement of Composite Particles Included in Inks>

The D₅₀ of the composite particles included in each ink was measured according to the method defined in ISO 22412:2017 using a dynamic light-scattering particle size distribution analyzer (“ZETASIZER 1000”, product of Malvern Instruments Ltd.). The measured D₅₀ of each type of the composite particles is shown in Tables 6 and 7.

[Evaluation]

Evaluation was performed as follows with respect to each of the inks (IA-1) to (IA-7), (IB-1) to (IB-5), and (IB-7) to (IB-11) as evaluation targets. Note that because the ink (IB-6) was not prepared as previously described, the ink (IB-6) was not evaluated.

<Dispersibility Evaluation>

The ink was filtered using a membrane filter (pore size: 5 μm). The mass of a solid remaining on the filter that had not passed through the filter was measured. The solid residual ratio was calculated from the formula “(solid residual ratio)=100×(solid mass remaining on filter)/(solid mass contained in ink)”. From the solid residual ratio, the dispersibility of the ink was evaluated according to the following criteria. Inks evaluated as A or B were determined to have good dispersibility, while inks evaluated as C were determined to have poor dispersibility. The evaluation results are shown in Tables 6 and 7.

(Dispersibility Evaluation Criteria)

Evaluation A: solid residual ratio was at least 0% by mass and no greater than 5% by mass.

Evaluation B: solid residual ratio was greater than 5% by mass and no greater than 10% by mass.

Evaluation C: solid residual ratio was greater than 10% by mass.

<Preservation Stability Evaluation>

The D₅₀ of the composite particles included in the ink was measured and taken to be a pre-storage D₅₀. Next, 30 mL of the ink was added into a container with a capacity of 50 mL, and the container was sealed. The container with the ink sealed therein was placed in a thermostatic chamber set to 60° C. and left for 1 week. Next, the D₅₀ of the composite particles included in the post-storage ink was measured and taken to be a post-storage D₅₀. Note that the pre-storage D₅₀ and the post-storage D₅₀ were measured by the same method as described above in <D₅₀ Measurement of Composite Particles Included in Ink>. A particle diameter change ratio was calculated from the formula “particle diameter change ratio=100×[(post-storage D₅₀)−(pre-storage D₅₀)]/(pre-storage D₅₀)”. From the particle diameter change ratio, the preservation stability of the ink was evaluated according to the following criteria. The evaluation results are shown in Tables 6 and 7. Inks evaluated as A or B were determined to have good preservation stability, while inks evaluated as C were determined to have poor preservation stability. The evaluation results are shown in Tables 6 and 7.

(Preservation Stability Evaluation Criteria)

Evaluation A: particle diameter change rate was less than 5%.

Evaluation B: particle diameter change ratio was at least 5% and no greater than 10%.

Evaluation C: particle diameter change rate was greater than 10%.

<Creation of Evaluation Textile Print>

An evaluation textile print used for later described image evaluation, color fastness to rubbing evaluation, and evaluation related to tactile degradation inhibition was created by the following method. An inkjet textile printing jig including a recording head (inkjet print head “KJ4B”, product of Kyocera, Inc.) was used. An ink tank corresponding to the color of the ink was filled with the ink. The filled ink tank was set in the jig. Using the inkjet textile printing jig, a solid image with an image density of 100% was printed on a polyester cloth (TETORON (registered Japanese trademark) pongee cloth) being a textile printing target. Next, the ink was dried by heating the textile printing target for 60 seconds at 180° C. to obtain an evaluation textile print.

<Image Evaluation>

Loupe observation using a loupe with 50× magnification and unaided observation were performed on the image printed on the evaluation textile print. The presence or absence of image defects in the image was confirmed. Image streaks and density unevenness were confirmed as image defects. Note that image streaks are caused by nozzle clogging or irregular ink ejection from nozzles. Based on the confirmation results of the presence or absence of image defects, the image was evaluated according to the following criteria. Inks with an evaluation of 3 or higher were determined to form good images, while inks with an evaluation of 2 or lower were determined to form poor images. The evaluation results are shown in Tables 6 and 7.

(Image Evaluation Criteria)

Evaluation 5: no image defects were confirmed by either loupe observation or unaided observation.

Evaluation 4: slight image defects were confirmed by loupe observation, but no image defects were confirmed by unaided observation.

Evaluation 3: clear image defects were confirmed by loupe observation, but no image defects were confirmed by unaided observation.

Evaluation 2: clear image defects were confirmed by loupe observation, and slight image defects were confirmed by unaided observation.

Evaluation 1: clear image defects were confirmed by both loupe observation and unaided observation.

<Color Fastness to Rubbing Evaluation>

The solid image printed on the evaluation textile print was rubbed using a white cotton rubbing cloth according to dry testing and wet testing of the rubbing testing apparatus type II (Gakushin type) method defined in JIS L-0849:2013 (test methods for color fastness to rubbing testing). The degree of coloring on the white cotton rubbing cloth was evaluated after rubbing under the “discoloration determination criteria” mentioned in Item 10 (color fastness determination) of JIS L-0801:2011 (general principles of testing methods for color fastness testing). The degree of coloring on the white cotton rubbing cloth was determined in 9 levels (in decreasing order from the highest degree of contamination: level 1, level 1-2, level 2, level 2-3, level 3, level 3-4, level 4, level 4-5, and level 5). The determination result of the above dry testing was taken to be a color fastness to dry rubbing, and the determination result of the above wet testing was taken to be a color fastness to wet rubbing. The degree of color fastness to rubbing is more favorable as the degree of coloring on the white cotton rubbing cloth decreases (approaches level 5). The color fastness to dry rubbing and the color fastness to wet rubbing was evaluated according to the following criteria from the degree of coloring on the white cotton rubbing cloth after rubbing testing. The evaluation results are shown in Tables 6 and 7.

(Color Fastness to Dry Rubbing Evaluation Criteria)

Good: degree of color fastness to dry rubbing was at least level 4.

Poor: degree of color fastness to dry rubbing was less than level 4.

(Color Fastness to Wet Rubbing Evaluation Criteria)

Good: degree of color fastness to wet rubbing was at least level 3.

Poor: degree of color fastness to wet rubbing was less than level 3.

<Evaluation Related to Tactile Degradation Inhibition>

Three items, that is, sagging, sliminess, and swelling resistance of the evaluation cloth were each evaluated by hand-touching the evaluation textile print in three levels of A (good), B (mediocre), and C (poor). The less degradation in sagging of the evaluation textile print, the more favorable the evaluation of sagging. The less sliminess in the evaluation textile print, the more favorable the evaluation of sliminess. The smaller the swelling of the evaluation textile print, the more favorable the evaluation of swelling resistance. Whether tactile degradation of the evaluation textile print was inhibited was then evaluated according to the following criteria. Inks evaluated as 3 or higher were determined to have inhibited the tactile degradation of the textile print, and inks evaluated as 2 or lower were determined not to have inhibited the tactile degradation of the textile print. The evaluation results are shown in Tables 6 and 7.

(Evaluation Criteria Related to Tactile Degradation Inhibition)

Evaluation 5: out of the three evaluation items, all three were A.

Evaluation 4: out of the three evaluation items, two were A. Out of the three evaluation items, none were C.

Evaluation 3: out of the three evaluation items, one was A. Out of the three evaluation items, none were C.

Evaluation 2: out of the three evaluation items, none were A. Out of the three evaluation items, one or two were C.

Evaluation 1: out of the three evaluation items, none were A. Out of the three evaluation items, all three were C.

TABLE 6

| | | Example 1 | Example 2 | Example 3 | Example 4 | Example 5 | Example 6 | Example 7 |
|---|---|---|---|---|---|---|---|---|
| Ink | | IA-1 | IA-2 | IA-3 | IA-4 | IA-5 | IA-6 | IA-7 |
| Composite | Dispersion | D-C1 | D-C2 | D-C3 | D-C4 | D-C5 | D-C6 | D-C3 |
| particles | Colored resin | C1 | C2 | C3 | C4 | C5 | C6 | C3 |
| | NaOH amount [g] | 5 | 17 | 23 | 8 | 6 | 5 | 73 |
| | D₅₀ [nm] | 180 | 110 | 05 | 125 | 176 | 85 | 95 |
| Cross-linking | Type | CX | CX | CX | CX | SU | SU | CX |
| agent | Amount [g] | 1.0 | 0.8 | 1.2 | 1.0 | 1.5 | 1.5 | 2.0 |
| Evaluation | Dispersibility | B | A | A | A | B | A | A |
| | Preservation stability | B | A | A | A | A | A | A |
| | Image | 3 | 4 | 5 | 4 | 4 | 5 | 5 |
| | Dry rubbing [level] | 4 | 4-5 | 4 | 4-5 | 4 | 4-5 | 5 |
| | Wet rubbing [level] | 4 | 3-4 | 3 | 4 | 4 | 3-4 | 4 |
| | Tactility | 5 | 3 | 5 | 4 | 4 | 3 | 3 |

TABLE 7

| | | Compar- | Compar- | Compar- | Compar- | Compar- | Compar- | Compar- | Compar- | Compar- | Compar- | Compar- |
|---|---|---|---|---|---|---|---|---|---|---|---|---|
| | | ative | ative | ative | ative | ative | ative | ative | ative | ative | ative | ative |
| | | Example | Example | Example | Example | Example | Example | Example | Example | Example | Example | Example |
| | | 1 | 2 | 3 | 4 | 5 | 6 | 7 | 8 | 9 | 10 | 11 |
| Ink | | IB-1 | IB-2 | IB-3 | IB-4 | IB-5 | IB-6 | IB-7 | IB-8 | IB-9 | IB-10 | IB-11 |
| Com- | Dis- | D-D1 | D-D2 | D-D3 | D-D4 | D-D5 | D-D6 | D-C2 | D-D7 | D-D8 | D-D9 | D-D10 |
| posite | persion | | | | | | (un- | | | | | |
| par- | | | | | | | formable) | | | | | |
| ticles | Colored | D1 | D2 | D3 | D4 | D5 | D6 | C2 | D7 | D8 | D9 | D10 |
| | resin | | | | | | | | | | | |
| | NaOH | 8 | 3 | 6 | 26 | 5 | 5 | 12 | 6 | 3 | 3 | 8 |
| | amount | | | | | | | | | | | |
| | [g] | | | | | | | | | | | |
| | D₅₀ [nm] | 140 | 400 | 185 | 80 | 100 | — | 110 | 195 | 300 | 650 | 600 |
| Cross- | Type | CX | CX | CX | CX | CX | — | none | CX | CX | CX | CX |
| linking | Amount | 1.0 | 1.0 | 0.8 | 1.0 | 1.0 | — | none | 1.0 | 1.0 | 1.0 | 1.0 |
| agent | [g] | | | | | | | | | | | |
| Eval- | Disper- | B | C | B | A | A | — | A | C | C | C | C |
| uation | sibility | | | | | | | | | | | |
| | Pres- | C | A | B | A | B | — | A | B | C | C | C |
| | ervation | | | | | | | | | | | |
| | stability | | | | | | | | | | | |
| | Image | 4 | 1 | 3 | 4 | 3 | — | 4 | 2 | 1 | 1 | 1 |
| | Dry | 3-4 | 4 | 3 | 4 | 4 | — | 3-4 | 4 | 4 | 4 | 3 |
| | rubbing | | | | | | | | | | | |
| | [level] | | | | | | | | | | | |
| | Wet | 3-4 | 4 | 3 | 2 | 2-3 | — | 2-3 | 4 | 4 | 4 | 3 |
| | rubbing | | | | | | | | | | | |
| | [level] | | | | | | | | | | | |
| | Tactility | 3 | 4 | 1 | 4 | 2 | — | 4 | 4 | 4 | 4 | 4 |

The terms in Tables 6 and 7 are defined as follows.

Dispersion: dispersion containing composite particles.

Colored resin: colored resin used in formation of composite particles contained in dispersion.

NaOH amount: mass (unit: g) of IN sodium hydroxide aqueous solution added in [Composite Particle Dispersion Preparation] described above.

D₅₀: D₅₀ of composite particles included in ink.

CX: blocked isocyanate (“MEIKANATE CX”, product of Meisei Chemical Works, Ltd.).

SU: blocked isocyanate (“SU-268A”, product of Meisei Chemical Works, Ltd.).

Dry rubbing: evaluation of color fastness to dry rubbing.

Wet rubbing: evaluation of color fastness to wet rubbing.

Tactility: evaluation related to tactile degradation inhibition.

−: preparation, measurement, and evaluation of ink were not performed because composite particles were not able to be formed.

As shown in Table 3, the resin (B1) had a glass transition point of less than 45° C. The colored resin (D1) was prepared using the resin (B1) as shown in Table 5, the dispersion (D-D1) was prepared using the colored resin (D1) as shown in Table 7, and the ink (IB-1) was prepared using the dispersion (D-D1). The evaluation results of the preservation stability and color fastness to dry rubbing of the ink (IB-1) were all poor as shown in Table 7.

As shown in Table 3, the resin (B2) had an acid value of less than 10 mgKOH/g and a hydroxyl value of less than 20 mgKOH/g. The colored resin (D2) was prepared using the resin (B2) as shown in Table 5, the dispersion (D-D2) was prepared using the colored resin (D2) as shown in Table 7, and the ink (IB-2) was prepared using the dispersion (D-D2). The evaluation results of the dispersibility and image of the ink (IB-2) were all poor as shown in Table 7.

As shown in Table 3, the resin (B3) had a glass transition point of higher than 75° C. The colored resin (D3) was prepared using the resin (B3) as shown in Table 5, the dispersion (D-D3) was prepared using the colored resin (D3) as shown in Table 7, and the ink (IB-3) was prepared using the dispersion (D-D3). The evaluation results of the color fastness to dry rubbing and tactile degradation inhibition of the ink (IB-3) were all poor as shown in Table 7.

As shown in Table 3, the resin (B4) had an acid value of greater than 70 mgKOH/g. The colored resin (D4) was prepared using the resin (B4) as shown in Table 5, the dispersion (D-D4) was prepared using the colored resin (D4) as shown in Table 7, and the ink (IB-4) was prepared using the dispersion (D-D4). The evaluation result of the color fastness to wet rubbing of the ink (IB-4) was poor as shown in Table 7.

As shown in Table 3, the resin (B5) had a hydroxyl value of greater than 60 mgKOH/g. The colored resin (D5) was prepared using the resin (B5) as shown in Table 5, the dispersion (D-D5) was prepared using the colored resin (D5) as shown in Table 7, and the ink (IB-5) was prepared using the dispersion (D-D5). The evaluation results of the color fastness to wet rubbing and tactile degradation inhibition of the ink (IB-5) were all poor as shown in Table 7.

The colored resin (D6) was prepared using the resin (B6) as shown in Table 5. However, as shown in Table 7, composite particles were not formed using the colored resin (D6). Specifically, the colored resin (D6) dissolved in the water phase during phase inversion emulsification, and the phase inversion emulsification did not proceed, leading to no formation of emulsified composite particles. As a result, the dispersion (D-D6), and therefore the ink (IB-6), was not able to be prepared. As shown in Table 7, the ink (IB-6) was not able to be evaluated. Note that the ink (IB-6) that was attempted to be prepared was outside the scope of the present disclosure due to not including composite particles as the composite particles were not able to be formed.

As shown in Table 7, the ink (IB-7) did not contain a cross-linking agent. The evaluation results of the color fastness to dry rubbing and color fastness to wet rubbing of the ink (IB-7) were all poor as shown in Table 7.

As shown in Table 3, the resin (B7) had a hydroxyl value of less than 20 mgKOH/g. The colored resin (D7) was prepared using the resin (B7) as shown in Table 5, the dispersion (D-D7) was prepared using the colored resin (D7) as shown in Table 7, and the ink (IB-8) was prepared using the dispersion (D-D7). The evaluation results of the dispersibility and image of the ink (IB-8) were all poor as shown in Table 7.

As shown in Table 3, the resin (B8) had an acid value of less than 10 mgKOH/g. The colored resin (D8) was prepared using the resin (B8) as shown in Table 5, the dispersion (D-D8) was prepared using the colored resin (D8) as shown in Table 7, and the ink (IB-9) was prepared using the dispersion (D-D8). The evaluation results of the dispersibility, preservation stability, and image of the ink (IB-9) were all poor as shown in Table 7.

As shown in Table 3, the resin (B9) had a glass transition point of less than 45° C., an acid value of less than 10 mgKOH/g, and a hydroxyl value of less than 20 mgKOH/g. The colored resin (D9) was prepared using the resin (B9) as shown in Table 5, the dispersion (D-D9) was prepared using the colored resin (D9) as shown in Table 7, and the ink (IB-10) was prepared using the dispersion (D-D9). The evaluation results of the dispersibility, preservation stability, and image of the ink (IB-10) were all poor as shown in Table 7.

As shown in Table 5, the resin (B10) was not a non-crystalline polyester resin. The colored resin (D10) was prepared using the resin (B10) as shown in Table 5, the dispersion (D-D10) was prepared using the colored resin (D10) as shown in Table 7, and the ink (IB-11) was prepared using the dispersion (D-D10). The evaluation results of the dispersibility, preservation stability, image, and color fastness to dry rubbing of the ink (IB-11) were all poor as shown in Table 7.

By contrast, each of the inks (IA-1) to (IA-7) had the following features. That is, each of these inks included the aqueous medium, the composite particles, and the cross-linking agent. As shown in Table 4, the polyester resin contained in the composite particles (specifically, each of the resins (A1) to (A6)) was non-crystalline. As shown in Table 2, the polyester resin (specifically, each of the resins (A1) to (A6)) had a glass transition point of at least 45° C. and no higher than 75° C., an acid value of at least 10 mgKOH/g and no greater than 70 mgKOH/g, and a hydroxyl value of at least 20 mgKOH/g and no greater than 60 mgKOH/g. As shown in Table 7, the cross-linking agent contained in each of these inks included the blocked isocyanate (specifically, MEIKANATE CX or SU-268A). The evaluation results of the dispersibility, preservation stability, image, color fastness to dry rubbing, color fastness to wet rubbing, and tactile degradation inhibition of the inks (IA-1) to (IA-7) were all good as shown in Table 6.

From the above, it was shown that the ink according to the present disclosure encompassing the inks (IA-1) to (IA-7) and the ink produced by the production method according to the present disclosure have excellent dispersibility and preservation stability, can enable textile printing of an image with few image defects and excellent color fastness to rubbing, and can inhibit tactile degradation of a textile print. Furthermore, according to the inkjet textile printing method of the present disclosure which used such an ink, it is determined that use of an ink with excellent dispersibility and preservation stability can inhibit agglomeration of the ink, achieve textile printing of an image with few image defects and excellent color fastness to rubbing, and inhibit tactile degradation of a textile print.

What is claimed is:

1. An inkjet ink comprising:
an aqueous medium;
composite particles; and
a cross-linking agent, wherein
the composite particles are emulsified particles of a composite of a polyester resin and a disperse dye,
the polyester resin includes at least one repeating unit derived from a polyhydric alcohol and at least one repeating unit derived from a polybasic carboxylic acid,
the polyester resin is non-crystalline,
the polyester resin has a glass transition point of at least 45° C. and no higher than 75° C.,
the polyester resin has an acid value of at least 10 mgKOH/g and no greater than 70 mgKOH/g,
the polyester resin has a hydroxyl value of at least 20 mgKOH/g and no greater than 60 mgKOH/g, and
the cross-linking agent includes a blocked isocyanate.

2. The inkjet ink according to claim 1, wherein
the at least one repeating unit derived from a polyhydric alcohol includes at least a first repeating unit derived from a tri- or higher-hydric alcohol, and
the first repeating unit has a content ratio of at least 0.5 mol % and no greater than 10.0 mol % in a total amount of the at least one repeating unit derived from a polyhydric alcohol.

3. The inkjet ink according to claim 1, wherein
the at least one repeating unit derived from a polyhydric alcohol includes at least a second repeating unit derived from ethylene glycol, and
the second repeating unit has a content ratio of at least 50.0 mol % and no greater than 90.0 mol % in a total amount of the at least one repeating unit derived from a polyhydric alcohol.

4. The inkjet ink according to claim 1, wherein
the at least one repeating unit derived from a polybasic carboxylic acid includes at least a third repeating unit derived from a tri- or higher-basic carboxylic acid, and
the third repeating unit has a content ratio of at least 0.5 mol % and no greater than 9.0 mol % in a total amount of the at least one repeating unit derived from a polybasic carboxylic acid.

5. The inkjet ink according to claim 1, wherein,
the at least one repeating unit derived from a polybasic carboxylic acid includes at least a fourth repeating unit derived from a polybasic carboxylic acid with a sulfonic acid group, and
the fourth repeating unit has a content ratio greater than 0.0 mol % and no greater than 15.0 mol % in a total amount of the at least one repeating unit derived from a polybasic carboxylic acid, or
the at least one repeating unit derived from a polybasic carboxylic acid does not include the fourth repeating unit.

6. The inkjet ink according to claim 1, wherein
the at least one repeating unit derived from a polybasic carboxylic acid includes at least a fifth repeating unit derived from a polybasic carboxylic acid with an aromatic hydrocarbon,
the at least one repeating unit derived from a polyhydric alcohol includes at least a sixth repeating unit derived from a polyhydric alcohol with an aromatic hydrocarbon, and
a total content ratio of the fifth repeating unit and the sixth repeating unit is at least 50 mol % in a total amount of the at least one repeating unit derived from a polybasic carboxylic acid and the at least one repeating unit derived from a polyhydric alcohol.

7. The inkjet ink according to claim 1, wherein
the polyester resin has a content ratio of at least 50% by mass and less than 100% by mass in the composite particles.

8. The inkjet ink according to claim 1, wherein
the composite particles have a volume median diameter of at least 20 nm and no greater than 300 nm.

9. The inkjet ink according to claim 1, further comprising a neutralizer.

10. An inkjet textile printing method comprising
ejecting an ink from a recording head onto a textile printing target, wherein
the ink is the inkjet ink according to claim 1.

11. The inkjet textile printing method according to claim 10, further comprising
heating the ink landed on the textile printing target, wherein
the textile printing target has a hydroxy group, and
in the heating the ink, the cross-linking agent cross-links the hydroxy group in the textile printing target and a hydroxy group in the polyester resin contained in the composite particles.
